(19) United States
(12) Patent Application Publication
(10) Pub. No.: US 2025/0296842 A1
(43) Pub. Date: Sep. 25, 2025

(54) INTEGRATED PRODUCTION OF THIOPHENE AND CARBON NANOTUBES

(71) Applicant: ExxonMobil Technology and Engineering Company, Spring, TX (US)

(72) Inventors: Guang Cao, Princeton, NJ (US); Kun Wang, Branchburg, NJ (US); Partha Nandi, Annandale, NJ (US); August W. Bosse, Pennington, NJ (US); Vera Grankina, Doylestown, NJ (US)

(73) Assignee: ExxonMobil Technology and Engineering Company, Spring, TX (US)

(21) Appl. No.: 18/863,950

(22) PCT Filed: May 4, 2023
(86) PCT No.: PCT/US2023/020970

§ 371 Date: Nov. 7, 2024

Related U.S. Application Data
(60) Provisional application No. 63/349,738, filed on Jun. 7, 2022.

(51) Int. Cl. C01B 32/164

(52) U.S. Cl. CPC C01B 32/164; C01P 2002/01; C01P 2004/13

(57) ABSTRACT

Systems and methods are provided for integrated production of both thiophene (and/or substituted thiophenes) and carbon nanotubes. The product effluent from thiophene synthesis can include thiophene, a sulfur-containing organic compound, and unreacted hydrocarbons from the thiophene synthesis process. Such a product effluent can be used as a feed for carbon nanotube synthesis. The effluent provides hydrocarbons for pyrolysis to form H₂ and carbon. Additionally, the thiophene provides sulfur that can be used for in-situ catalyst formation for formation of carbon nanotubes.

### RELATED APPLICATIONS

This application is a national stage application, filed under 35 U.S.C. 371, of International Patent Application No. PCT/US2023/020970, filed May 4, 2023, which claims the priority to U.S. Provisional Application No. 63/349,738 filed Jun. 7, 2022, which is incorporated by reference in its entirety.

### FIELD OF THE INVENTION

Systems and methods are provided for integrated production of thiophene and/or substituted thiophenes along with carbon nanotubes.

### BACKGROUND OF THE INVENTION

Thiophene and alkyl-substituted thiophenes are currently produced commercially by vapor phase reaction of alcohols with a sulfur source (such as carbon disulfide) in the presence of an oxide catalyst. An example of an oxide catalyst is Cr₂O₃ supported on a substrate including Al₂O₃ and K₂CO₃. While this can allow for thiophene production, the alcohols needed as reagents correspond to specialty chemicals. This substantially increases the cost for production of thiophene, which limits the potential applications for products made from such thiophene.

It would be desirable to have alternative methods to allow for production of thiophene at reduced cost. This could potentially increase the number and/or type of applications available for use of thiophene. For example, polythiophene corresponds to a conjugated polymer. Conjugated polymers (such as Kevlar®) can often have favorable tensile strengths and/or other properties that are beneficial for use as structural materials. Thus, if thiophene (and therefore polythiophene) could be produced at lower cost, applications for use of polythiophene as a structural material could become attractive. Additionally, oxidized and/or doped polythiophenes can potentially be used as conductive polymers.

Another process of increasing interest is pyrolysis of hydrocarbons to form hydrogen. Pyrolysis of hydrocarbons to form hydrogen provides a pathway for converting hydrocarbons to H₂, a clean burning fuel, and solid carbon. In terms of CO₂ emissions, using pyrolysis of hydrocarbons to generate H₂ can potentially provide a way to reduce or minimize CO₂ emissions without requiring carbon capture technology to be deployed for every process that requires a fuel for combustion. However, a variety of challenges remain for implementing hydrocarbon pyrolysis for H₂ generation as a fuel on a commercial scale.

One of the difficulties with using pyrolysis to generate H₂ as a fuel is that a substantial quantity of solid carbon is also generated as a side product. Solid carbon is a relatively low value material, and if the option of using the solid carbon as a fuel for combustion is removed, the value of solid carbon is often negative (i.e., the carbon is disposed of rather than sold as a valuable product). For generation of H₂ by hydrocarbon pyrolysis to become a commercially viable technology, it would be desirable to have systems or methods that can allow the pyrolysis reaction to form a carbon product with a positive value rather than a negative value.

One option for forming a carbon product with a positive value is to combine the hydrocarbon pyrolysis process with a pyrolysis for carbon nanotube formation. Carbon nanotubes have a variety of commercially beneficial properties, so even a modest yield of carbon nanotubes could substantially improve the economics of a hydrocarbon pyrolysis process. However, carbon nanotube formation is currently a laboratory scale process, performed in reactors that produce on the order of grams per day of carbon nanotubes. While existing small-scale reactors could potentially be used in parallel to make larger quantities of carbon nanotubes, such a scale-up would pose substantial engineering challenges. First, a variety of complicated manifolds would likely be needed in order to manage the input flows, output H₂ flows, and the extraction of the carbon nanotubes. Additionally, the difficulty of simultaneously providing the heat necessary for pyrolysis to a large number of individual reactors would need to be resolved. The equipment footprint required for handling this scale-up configuration would also likely be substantial. Therefore, it would be beneficial if systems and/or methods were available that would allow for commercial scale production of carbon nanotubes and H₂ while avoiding the substantial engineering challenges of using a large plurality of small reactors.

One example of an alternative process for thiophene production is to use n-butane (or another alkane) in place of the alcohol. U.S. Pat. No. 3,939,179 describes an example of a catalytic process for conversion of n-butane and H₂S to form thiophene. A variety of metal oxides supported on refractory oxides are described as catalyst precursors, including a combination of potassium oxide and chromium oxide supported on alumina.

30 Another option can be to operate with increased temperature without the use of a catalyst. U.S. Pat. No. 2,450,658 describes an example of this type of process. While this type of process can result in thiophene production, the per-pass conversion rate for n-butane is limited, meaning that substantial recycle is needed in order to achieve high net conversion. Additionally, the thiophene synthesis conditions result in substantial formation of a tar-like product. It is further noted that the results reported for the example for thiophene synthesis from n-butene, based on mass balance, appear to be missing a substantial amount of the carbon from the input flows. Based on the relatively thorough characterization of the other products, this potentially indicates that a substantial amount of coke was made, which would be consistent with the higher temperature operation required for achieving substantial conversion of n-butane without a catalyst.

U.S. Pat. No. 9,061,913 describes an apparatus for production of carbon nanotubes. The apparatus provides a method for introducing the input flows for the reaction in the form of droplets.

A journal article titled “Mapping the Parameter Space for Direct-Spun Carbon Nanotube Aerogels” (Weller et al., Carbon, Vol. 146, pg 789 (2019)) describes conditions that can be used for formation of single wall carbon nanotubes and multi-wall carbon nanotubes.

A journal article titled “Initial Competing Chemical Pathways during Floating Catalyst Chemical Vapor Deposition Carbon Nanotube Growth” (McLean et al., J. Appl. Phys. Vol. 129, pg 044302 (2021)) describes simulations related to initial formation of carbon nanotube structures using floating catalyst—chemical vapor deposition type catalysts.

A journal article titled “Catalytic Decomposition of Methane into Hydrogen and High-Value Carbons: Combined Experimental and DFT Computational Study” (Wang et al., Cat. Sci. Technol. Vol. 11, pg 4911 (2021)) describes a process for recycling metal from carbon nanotubes for use as a catalyst for forming additional carbon nanotubes.

### SUMMARY OF THE INVENTION

In an aspect, a method of making carbon nanotubes is provided. The method includes exposing a first feedstock containing one or more C₄ to C₁₆ alkanes and a second feedstock containing a gas phase sulfur source to a synthesis catalyst under thiophene synthesis conditions, to form a synthesis effluent containing thiophenes, alkylated thiophenes, or a combination thereof. The method further includes heating a gas flow to a temperature of 1000° C. or more to form a heated gas flow. The method further includes passing the heated gas flow into a reactor comprising a pyrolysis zone, the pyrolysis zone having an average cross-sectional area that is available for gas flow. The method further includes mixing i) a catalytic metal precursor comprising a catalytic metal and ii) at least a portion of the synthesis effluent with the heated gas flow to form a heated gas flow mixture, the heated gas flow mixture containing 10 vol % or less of hydrocarbons, thiophenes, and alkylated thiophenes. The method further includes maintaining the heated gas flow mixture in the pyrolysis zone at a temperature of 1000° C. or more for a pyrolysis residence time to form an intermediate product flow containing H₂, carbon, and catalyst including the catalytic metal. The method further includes cooling the intermediate product flow to a temperature of 800° C. or less. Additionally, the method includes passing the intermediate product flow into an array of gas flow tubes within the reactor to form a carbon nanotube product flow. In some aspects, a ratio of an average cross-sectional area of the pyrolysis zone that is available for gas flow to an average cross-sectional area of the array of gas flow tubes is 1.1 or more. Additionally or alternately, in some aspects a ratio of an average cross-sectional of the pyrolysis zone that is available for gas flow to an average cross-sectional area of a tube in the array of gas flow tubes is 10 or more.

### BRIEF DESCRIPTION OF THE DRAWINGS

FIG. 1 shows an example of a reaction system for synthesis of thiophene.

FIG. 2 shows an example of a reaction system for forming carbon nanotubes.

FIG. 3 shows a transmission electron micrograph of a sulfided catalyst a layered chromium sulfide phase.

FIG. 4 shows examples of compounds produced during a thiophene synthesis process.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various aspects, systems and methods are provided for integrated production of both thiophene (and/or substituted thiophenes) and carbon nanotubes. The product effluent from thiophene production can include thiophene (and/or substituted thiophenes), a sulfur-containing organic compound, and unreacted hydrocarbons from the thiophene synthesis process. Such a product effluent can be used as a feed for carbon nanotube synthesis. The effluent provides hydrocarbons for pyrolysis to form H₂ and carbon. Additionally, the thiophene provides sulfur that can be used for in-situ catalyst formation for formation of carbon nanotubes.

The metal components needed for in-situ catalyst formation can be provided in any convenient manner. In some aspects, a metal-containing precursor such as ferrocene can be used as the reagent for in-situ catalyst formation. Additionally or alternately, metal for in-situ catalyst formation can be provided based on a metal recycle process that includes using a portion of carbon nanotubes to form the catalyst. The carbon nanotubes can correspond to a recycled portion of the nanotubes and/or fresh nanotubes made in a different process.

In some aspects, the thiophene can be synthesized using a catalyst that provides improved results when producing thiophene by conversion of n-butane (and/or other alkanes) and a gas phase sulfur-containing compound, such as CS₂, H₂S, S₂, or another form of sulfur. The catalyst can correspond to chromium sulfide(s) supported on a zeotype support, such as a substantially alkali-metal form zeotype support or alkaline earth-metal form zeotype support.

Methods for producing the catalyst and a corresponding catalyst precursor are also provided. Additionally, methods for producing thiophene and/or alkylated thiophenes are also provided.

### Definitions

In this discussion, a zeotype is defined to refer to a crystalline material having a porous framework structure built from tetrahedra atoms connected by bridging oxygen atoms. Examples of known zeotype frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. In this discussion, a zeolite generally refers to crystalline structures having zeotype frameworks that contain only oxides of silicon and aluminum. In this discussion, a zeotype generally refers to crystalline structures having zeotype frameworks that are either zeolites or that may also containing oxides of heteroatoms different from silicon and aluminum. Such heteroatoms can include any heteroatom generally known to be suitable for inclusion in a zeotype framework, such as gallium, boron, germanium, phosphorus, zinc, and/or other transition metals that can substitute for silicon and/or aluminum in a zeotype framework. It is noted that under this definition, a zeotype can include materials such as silicoaluminophosphate (SAPO) materials, silicophosphate (SiPO) materials, or aluminophosphate (AIPO) materials.

A support material that includes a zeotype framework structure (i.e., a crystalline structure corresponding to a zeotype framework) can be referred to as a zeotype support.

Optionally, a zeotype support (such as a zeolitic support) can include one or more oxides as a binder material in the support.

In this discussion, alkali metals include metals from Group 1 of the IUPAC Periodic Table, including lithium, sodium, potassium, rubidium, and cesium. In this discussion, alkaline earth metals include metals from Group 2 of the IUPAC Periodic Table, including magnesium, calcium, strontium, and barium.

In this discussion, an alkylated thiophene is defined as a thiophene that includes one or more alkyl chains attached to the thiophene ring.

In this discussion, Alpha value is a measure of the cracking activity of a catalyst and is described in U.S. Pat. No. 3,354,078 and in the Journal of Catalysis, Vol. 4, p. 527 (1965); Vol. 6, p. 278 (1966); and Vol. 61, p. 395 (1980), each incorporated herein by reference as to that description. The experimental conditions of the test used herein include a constant temperature of 538° C. and a variable flow rate as described in detail in the Journal of Catalysis, Vol. 61, page 395.

In this discussion, a “substituted thiophene” is defined as any derivative that includes at least one thiophene ring. Thus, substituted thiophenes include alkylated thiophenes, where one or more alkyl carbon chains are attached to a thiophene ring. Substituted thiophenes also include oligomers of thiophene, such as compounds that may contain multiple thiophene rings and/or fused thiophene rings (e.g., bienothiophene). Substituted thiophenes further include other types of fused ring structures, such as benzothiophene.

### Thiophene Synthesis Conditions

In various aspects, thiophene synthesis can be performed by exposing a plurality of gas phase feedstocks to a thiophene synthesis catalyst. At least one feedstock can correspond to a feedstock containing C₄₊ alkanes, such as n-butane, a mixture of butanes, n-pentane, a mixture of n-butane and n-pentane, a mixture of butane(s) and pentane(s), n-hexane and/or any other convenient combination of alkanes that contain 4 or more carbons. The C₄₊ alkanes in the plurality of gas phase feedstocks can correspond to any convenient combination of n-alkanes and branched alkanes (i.e., alkanes that contain at least one branch but that do not include a ring structure). In some aspects, branched alkanes can correspond to 25 wt % or less of the total weight of alkanes in the gas phase feesdstocks, or 10 wt % or less, or 5.0 wt % or less, or 1.0 wt % or less, such as down to having substantially no content of branched alkanes. In some aspects, the plurality of gas phase feedstocks can include 10 wt % or less of C₅₊ hydrocarbons relative to the total weight of hydrocarbons in the gas phase feedstocks, or 5.0 wt % or less, or 1.0 wt % or less, such as down to having substantially no C₅₊ hydrocarbons. In some aspects, the C₄₊ alkanes can correspond to C₄ to C₁₆ alkanes, C₄ to C₁₂ alkanes, or C₄ to C₈ alkanes.

In some aspects the plurality of gas phase feedstocks can include 50 wt % or more of alkanes relative to the total weight of hydrocarbons in the gas phase feedstocks, or 75 wt % or more, or 90 wt % or more, or 95 wt % or more, or 99 wt % or more, such as up to having alkanes as substantially the only hydrocarbons in the gas phase feedstocks. Additionally or alternately, in some aspects the plurality of gas phase feedstocks can include 50 wt % or more of n-alkanes relative to the total weight of hydrocarbons in the gas phase feedstocks, or 75 wt % or more, or 90 wt % or more, or 95 wt % or more, or 99 wt % or more, such as up to having n-alkanes as substantially the only hydrocarbons in the gas phase feedstocks. Further additionally or alternately, in some aspects the plurality of gas phase feedstocks can include 50 wt % or more of n-butane relative to the total weight of hydrocarbons in the gas phase feedstocks, or 75 wt % or more, or 90 wt % or more, or 95 wt % or more, or 99 wt % or more, such as up to having n-butane as substantially the only hydrocarbon in the gas phase feedstocks.

Optionally, the plurality of feedstocks can also include C₄₊ alkenes. In some aspects, relative to the total hydrocarbons in the input flow(s), the C₄₊ alkenes can correspond to 25 wt % or less of the input flow(s), or 10 wt % or less, or 5.0 wt % or less, or 1.0 wt % or less, such as down to have substantially no alkenes in the gas phase feedstocks. The C₄₊ alkenes can correspond to n-butene (corresponding to 1-butene, cis-2-butene, trans-2-butene, or a combination thereof), isobutene, n-pentene, isopentane, n-hexene and/or any other convenient combination of n-alkenes and branched alkenes. Optionally, the C₄₊ alkenes can include dienes.

Additionally, at least one feedstock can correspond to a gas phase source of sulfur. Gas phase sources of sulfur can include, but are not limited to, H₂S, CS₂, S₂, and/or other forms of sulfur that can be present in a gas phase flow at temperatures near the reaction temperature for thiophene synthesis. The plurality of gas phase feedstocks can be introduced into a reactor as a single

stream, or the gas phase feedstocks can be introduced as a plurality of streams. The reactor volume (or a portion thereof) can serve as the reaction environment for the thiophene synthesis reaction. Optionally, when a plurality of streams are introduced into the reaction environment, different input streams can have different compositions. For example, one option can be to have a first feed stream containing one or more alkanes and a second feed stream containing one or more gas phase sulfur sources. Any convenient type of vessel can be used as a reactor, so long as the vessel is suitable for maintaining the reactants in the reaction environment at the synthesis conditions for an average synthesis residence time.

In various aspects, a molar ratio of sulfur atoms in the reaction environment to hydrocarbons in the reaction environment can range from 0.9 to 30 (i.e., range from 0.9 moles of sulfur atoms per mole of hydrocarbons to 30 moles of sulfur atoms per mole of hydrocarbons). In some aspects, the molar ratio of sulfur atoms to hydrocarbons in the reaction environment can be from 0.9 to 30, or 0.9 to 15, or 0.9 to 10, or 1.0 to 30, or 1.0 to 15, or 1.0 to 10, or 1.5 to 30, or 1.5 to 15, or 1.5 to 10, or 2.5 to 30, or 2.5 to 15, or 2.5 to 10. Additionally or alternately, the molar ratio of H2S to hydrocarbons in the reaction environment can be from 0.9 to 15, or 0.9 to 10, or 1.0 to 15, or 1.0 to 12, or 1.0 to 10, or 1.5 to 15, or 1.5 to 10, or 2.5 to 15, or 2.5 to 10.

In the reaction environment, the average residence time can be 0.01 seconds to 100 seconds, or 0.1 seconds to 100 seconds, or 1.0 second to 100 seconds, or 0.01 seconds to 50 seconds, or 0.1 seconds to 50 seconds, or 1.0 seconds to 50 seconds, or 0.01 seconds to 10 seconds, or 0.1 seconds to 10 seconds, or 1.0 seconds to 10 seconds. The temperature in the reaction environment can be 450° C. to 750° C., or 450° C. to 650° C., or 450° C. to 600° C., or 450° C. to 550° C., or 500° C. to 750° C., or 500° C. to 650° C., or 500° C. to 600° C., or 550° C. to 750° C., or 550° C. to 650° C. The pressure in the reaction environment can range from 0 kPa-g to 1750 kPa-g, or 0 kPa-g to 1050 kPa-g, or 0 kPa-g to 350 kPa-g, or 15 kPa-g to 1750 kPa-g, or 15 kPa-g to 1050 kPa-g, or 15 kPa-g to 350 kPa-g, or 150 kPa-g to 1750 kPa-g, or 150 kPa-g to 1050 kPa-g, or 150 kPag- to 350 kPa-g.

Exposing a feedstock corresponding to a gas phase sulfur source and a feedstock including alkanes (such as n-butane) to a thiophene synthesis catalyst can result in production of thiophene along with side products and/or unreacted reagents. The products from the reaction can include, but are not limited to, thiophene and/or alkylated thiophene; coke; a purge stream corresponding to C₄₋ or C₃₋ hydrocarbons; C₄ to C₁₀ hydrocarbons (including unreacted C₄₊ hydrocarbons); one or more sulfur compounds (such as H₂S, CS₂, S₂, and/or other forms of gas phase sulfur; and C₁₀₊ hydrocarbons. The C₁₀₊ hydrocarbons can, for example, be sent to a hydroprocessing unit for production of fuels. The C₄ to C₁₀ hydrocarbons can, for example, be used as a light alkane product; can be recycled back to the reactor; or a separation can be performed to at least partially separate olefins from the C₄ to C₁₀ hydrocarbons prior to recycle to the reactor. It is noted that other choices could be made for which hydrocarbons are recycled versus sent to hydroprocessing for forming fuels. For example, the intermediate hydrocarbon stream (optionally used for recycle) can correspond to a C₄ to C₆ stream, or a C₄ to C₈ stream, or a C₄ to C₁₀ stream, or a C₄ to C₁₂ stream, or a C₄ to C₁₆ stream. Depending on the hydrocarbons chosen for inclusion in the lighter hydrocarbon stream, the hydrocarbons used for fuel production can correspond to C₆₊ hydrocarbons, or C₈₊ hydrocarbons, or C₁₀₊ hydrocarbons, or C₁₂₊ hydrocarbons, or C₁₆₊ hydrocarbons. Still another option could be to separate the hydrocarbons into a larger plurality of fractions. In some aspects, depending on the efficiency of the separation, the “heavy” stream sent to hydroprocessing for fuel production may not have any overlap in composition with the recycle stream. For example, if the recycle stream corresponds to a C₄ to C₈ stream, the “heavy” stream may optionally correspond to a stream containing C₉₊ compounds, with a C₈₋ content of 5.0 wt % or less, or 1.0 wt % or less, such as down to having substantially no content of C₈₋ hydrocarbons.

During the thiophene synthesis reaction, some sulfur is consumed for production

of thiophene and/or alkylated thiophene. Because the thiophene synthesis conditions often include a stoichiometric excess of sulfur, at least a portion of the reaction products (including unreacted reagents) can typically correspond to some type of sulfur-containing compound. For example, in the reaction product stream identified above, one or more of the purge or light hydrocarbon stream (such as C₄₋), the intermediate hydrocarbon (such as C₄-C₁₀), and the heavy hydrocarbon stream (such as C₁₀₊) can include sulfided organic compounds. Due to the atomic weight of sulfur, this can cause some mixing of the carbon numbers present within a stream. For example, a C₈ sulfided compound could potentially correspond to a compound that is separated into a C₁₀₊ fraction.

### Reaction Products and Further Processing

After performing thiophene synthesis, various portions of the reaction products can undergo some type of further processing. One type of further processing can be to perform one or more separations to recover the thiophene and/or alkylated thiophenes from the remaining reaction products and/or unreacted reagents. This separation can also produce one or more additional streams, such as a stream of light hydrocarbons (C₃₋), a stream of intermediate hydrocarbons (such as C₄-C₁₀ hydrocarbons), a stream of heavier hydrocarbons (such as a C₁₀₊ stream), and a stream of H₂S. Optionally, CS₂ can also be a reaction side product. A substantial amount of coke is also formed.

Another type of further processing can be to use the reaction product effluent as a feed for synthesis of carbon nanotubes. In some aspects, the separated thiophene and/or alkylated thiophenes fraction can be used. In other aspects, the intermediate hydrocarbons (C₄-C₁₀) and/or the heavier hydrocarbons (C₁₀₊) can also be included as part of the feed for use in carbon nanotube synthesis. It is noted that separation of the thiophene, substituted thiophenes, and hydrocarbons only needs to be performed to the degree that such compounds are not included in the feed for carbon nanotube synthesis.

### Configuration Examples

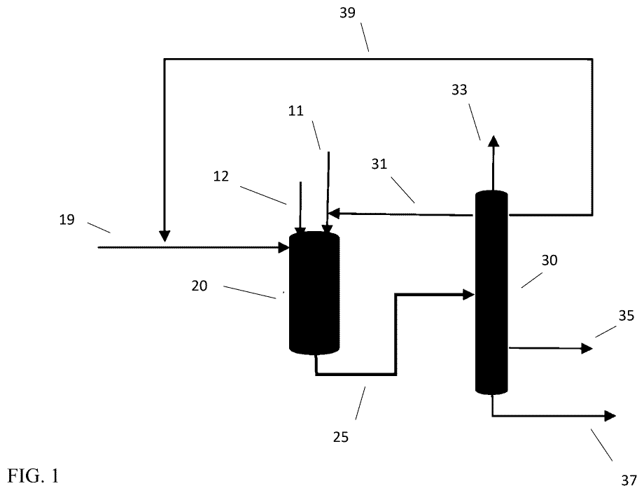

FIG. 1 shows an example of a reaction system configuration for production of thiophene. In FIG. 1, a feedstock 11 containing alkanes (such as n-butane or n-alkanes) and a gas phase sulfur feedstock 12 corresponding to S₂ (and/or other gas phase molecules containing only sulfur) can be introduced into a reactor 20. In the configuration shown in FIG. 1, feedstock 11 and gas phase sulfur feedstock 12 are shown as separate input streams. In other aspects, any convenient number of input flows can be used to introduce feedstock 11 and gas phase sulfur feedstock 12 into reactor 20. In addition to feedstock 11 and gas phase sulfur feedstock 12, one or more recycle streams can optionally be introduced into reactor 20. In the configuration shown in FIG. 1, the recycle streams include an H₂S recycle stream 39, an H₂S makeup stream 19, and a C₄₊ hydrocarbon recycle stream 31.

The reactor 20 can be used to perform a thiophene synthesis reaction. The effluent 25 from the reaction can then be passed into one or more separation stages. In FIG. 1, the one or more separation stages are represented by a fractionator 30. In the example configuration shown in FIG. 1, fractionator 30 can be used to separate effluent 25 into a plurality of streams. This can include hydrocarbon recycle stream 31, H₂S recycle stream 39, a light hydrocarbon (C₄₋ or C₃₋) purge stream 33, a product stream 35 that includes thiophene and/or alkylated thiophenes, and a heavy hydrocarbon stream 37 containing hydrocarbons that are (on average) higher boiling than the hydrocarbons in hydrocarbon recycle stream 31.

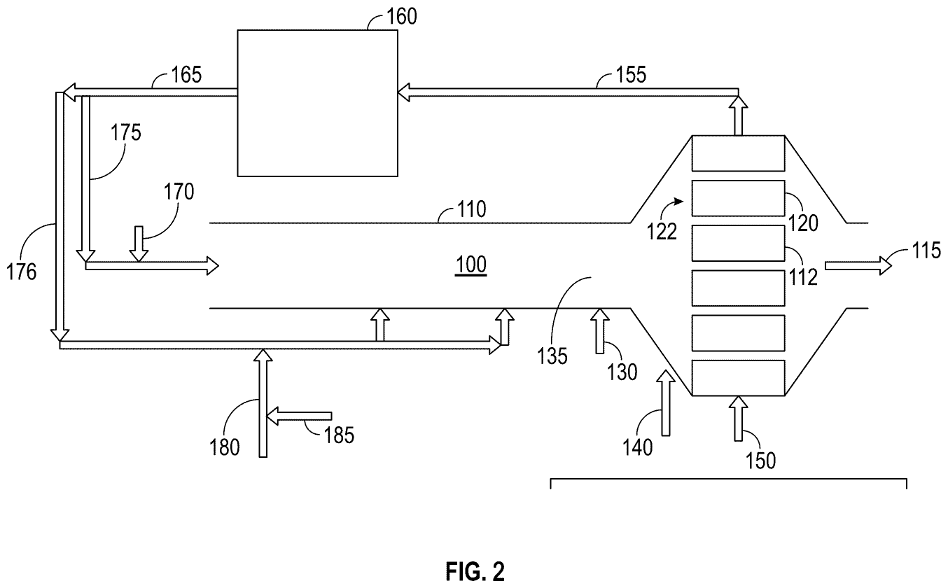

A reaction system configuration such as the configuration shown in FIG. I can be integrated with a larger overall synthesis scheme. For example, a reaction system for thiophene synthesis can be integrated with a reaction system for methane pyrolysis and carbon nanotube production. FIG. 2 shows an example of a system for methane pyrolysis and production of

carbon nanotubes. In FIG. 2, a reactor 100 corresponds to a reactor for forming carbon nanotubes. Reactor 100 can include a pyrolysis zone or section 110 and a carbon nanotube formation zone or section 120. During operation, a heated gas flow 175 can be introduced into the beginning of the pyrolysis zone 110 of reactor 100 via a heated gas flow conduit. The heated gas flow 175 can have a temperature of 1000° C. or more, or 1100° C. or more, or 1200° C. or more. A reactant flow 170 can be added to the heated gas flow 175 prior to entering the reactor 100 (i.e., in the heated gas flow conduit) or after entering the reactor 100. In the example shown in FIG. 2, reactant flow 170 includes both the catalyst precursors for the carbon nanotube formation catalyst and a portion of the hydrocarbon for pyrolysis. Alternatively, the catalyst precursors and the hydrocarbons for pyrolysis can be introduced as separate flows. Optionally, the secondary heated gas flow 176 can be used to introduce hydrocarbons 180 for pyrolysis at a downstream location within the pyrolysis zone 110. In some aspects, substantially all of the hydrocarbons introduced into the reactor can be included as part of secondary heated gas flow 176. In some aspects, an additional hydrocarbon flow 185 for generating free radicals in the reactor can be added to hydrocarbons 180.

In various aspects, at least a portion of the organic compounds in the reactant flow 170 can correspond to thiophene, substituted thiophens, and/or hydrocarbons from the reaction product effluent from thiophene synthesis. Using the reaction product effluent (or a portion thereof) from thiophene synthesis can provide a variety of benefits. For example, the reaction product effluent contains thiophene and/or substituted thiophenes, and therefore contains the sulfur that is needed for formation of the in-situ catalyst for carbon nanotube synthesis.

In some aspects, the metal for formation of the in-situ catalyst can be introduced as part of a recycle process that involves recovering metals previously used for formation of carbon nanotubes. When carbon nanotubes are synthesized using a method involving a catalyst such as an FC-CVD catalyst, the as-synthesized carbon nanotubes can contain metal nanoparticles within the nanotube structure and/or as part of the nanotube structure. These metal nanoparticles can be recovered from the nanotubes using an acid treatment. For example, the nanotubes can be refluxed with nitric acid in a series of stages with increasing nitric acid concentration to separate the carbon nanotubes from the incorporated metals. This metal recovery process allows the carbon nanotubes to remain substantially intact during the separation. The metals can then be recovered as solids from the nitric acid. After recovering the metal, the metal can be ground into a powder and then combined with a portion of the carbon nanotubes in a convenient solvent, such as acetone. The solution can be mixed and then heated in a closed vessel to form metal catalyst supported on the nanotubes. This supported catalyst can then be used as at least a portion of the metal precursor for forming the in-situ FC-CVD catalyst. An example of this metal recovery and recycle procedure is described in Wang et al., Cat. Sci. Technol. Vol. 11, pg 4911 (2021). More generally, any convenient similar method for recovering metal from carbon nanotubes and forming a recycled catalyst involving the recovered metal and carbon nanotubes can be used. Additionally or alternately, the metal can be introduced as a reagent, such as by including ferrocene in the heated gas flow.

After entering the reactor, the reactants in the heated gas flow can react. The catalyst precursors can react to form a catalyst for carbon nanotube formation. The hydrocarbons can be pyrolyzed to form H₂ and carbon atoms. These can be carried by the gas flow within reactor 100 from pyrolysis zone 110 to carbon nanotube formation zone 120. In the example shown in FIG. 2, a quench stream 130 is introduced to cool the gas flow prior to entering carbon nanotube formation zone 120. In this example, the location of quench stream 130 defines the end of pyrolysis zone 110 and the beginning of a quench zone 135. Optionally, steam 140 can be introduced after quench stream 130 to assist with gasifying amorphous carbon present in the gas flow.

In the example shown in FIG. 2, the carbon nanotube zone 120 corresponds to at least a portion of the shell of a shell and tube heat exchanger. The tubes 122 of the shell and tube heat exchanger include a heat transport fluid 150 for cooling the gas flow within the carbon nanotube formation zone to a temperature of 800° C. or less. In the example shown in FIG. 2, the heat transport fluid 150 can be the gas used in the heated gas flow 175, such as nitrogen and/or hydrogen. For example, when hydrogen is used as the gas for the heated gas flow 175, using hydrogen as the heat transport fluid 150 can allow the hydrogen to be heated to a temperature between 500° C. and 700° C. to form partially heated hydrogen 155. Optionally, the hydrogen used for heat transport fluid 150 can correspond to hydrogen recovered from the products 115. The partially heated hydrogen 155 can then be passed into a heater 160 to form heated hydrogen 165. The heated hydrogen 165 can then be used to form heated gas flow 175 and optional secondary heated gas flow 176.

As an alternative to the type of configuration shown in FIG. 2, in some aspects, the heat transfer fluid of a heat exchanger can be used to provide the recovered thermal energy to raise steam and/or generate power.

In the example shown in FIG. 2, the array of tubes for reducing the turbulence of the gas flow can correspond to tubes 112 that are interspersed between the tubes 122 of the shell and tube heat exchanger. After passing through the tubes, various products 115 can exit from the reactor. The products 115 can include H₂ formed during pyrolysis, carbon nanotubes, the gas from heated gas flow 175 that has passed through the reactor 110, and unreacted hydrocarbons.

It is noted that the elements shown in FIG. 2 can also be described with regard to the ability for fluids to pass from one element to the next. Such fluid communication between elements in a reaction system and/or within a reactor is defined as the ability for fluids to pass from a first element to a second element. Fluid communication can correspond to direct fluid communication or indirect fluid communication. In the example shown in FIG. 2, pyrolysis zone 110 is in direct fluid communication with quench zone 135. Pyrolysis zone 110 is in indirect fluid communication with the array of tubes 112 via quench zone 135.

Various options are available for integration of a thiophene synthesis reaction system (such as the configuration shown in FIG. 1) with a carbon nanotube synthesis reactor (such as the configuration shown in FIG. 2). One example of integration can be using a thiophene product such as thiophene product 35 (from FIG. 1) as the source of thiophene for reactant flow 170 in FIG. 2. The thiophene can be used in combination with ferrocene and/or recycled nanotubes and/or additional carbon nanotubes to form a floating catalyst—chemical vapor deposition (FC-CVD) catalyst for use in catalyzing nanotube formation. More generally, at least a portion of thiophene product 35 and/or heavy hydrocarbons 37 and/or light hydrocarbon purge 33 can be used as part of reactant flow 170 from FIG. 2. The light hydrocarbon purge can provide a source of carbon for the pyrolysis reaction prior to nanotube formation. Additionally, in some alternative aspects, heat integration between thiophene synthesis and carbon nanotube formation can be provided by forming the thiophen in-situ in the reactor for forming the carbon nanotubes.

### Carbon Nanotube Formation—Initial Heating and Formation of Catalyst

In various aspects, systems and methods are provided for production of carbon nanotubes and H₂ using a reaction system configuration that is suitable for large scale production. In the reaction system, a substantial portion of the heat for the reaction can be provided by using a heated gas stream. Optionally, the heated gas stream can correspond to a heated H₂ gas stream. By using a heated gas stream, when the catalyst precursors for the floating catalyst—chemical vapor deposition (FC-CVD) type catalyst are added to the gas stream, the gas stream can be at a temperature of 1000° C. or more. This can reduce or minimize loss of catalyst precursor material and/or deposition of coke on sidewalls of the reactor.

Additionally, a downstream portion of the reactor can include a plurality of flow channels of reduced size that are passed through a heat exchanger environment, such as a shell and tube heat exchanger. This can provide cooling of the gas flow after catalyst formation to allow for carbon nanotube formation, while also reducing the Reynolds number of the flow sufficiently to provide laminar flow within the region where carbon nanotubes are formed.

In various aspects, a reactor, reaction system, and method of operating the reactor/reaction system are provided that can overcome the various challenges in forming carbon nanotubes in a larger scale reactor. With regard to managing addition of heat to achieve the temperature for methane (or other hydrocarbon) pyrolysis, the reactor can be heated using a heated gas flow. The gas flow can be heated to a desired temperature prior to introducing the gas flow into the reactor. The various reactants, such as thiophene, substituted thiophenes, and/or hydrocarbons (for pyrolysis) and catalyst precursors (such as thiophene, substituted thiophenes, carbon nanotubes used as a support for metal recovered from previously synthesized nanotubes, and/or reagents such as ferrocene), can then be introduced into the gas flow at a location within the reactor or sufficiently close to the beginning of the reactor so that catalyst formation and/or methane pyrolysis occur substantially within the reactor. It is noted that after introduction of the reactants using one or more gas flows, the volume of the gas flow(s) for the reactants (e.g., thiophene, hydrocarbons, catalyst precursors) is on the order of a few percent relative to the combined volume of the heated gas flow and the reactants. As a result, even if the reactant gas flow(s) are not heated or only mildly heated prior to introduction into the reactor, the much larger volume of the heated gas flow can rapidly bring the reactants up to temperatures. In some aspects, the heated gas flow can correspond to a hydrogen gas flow, such as hydrogen generated by the pyrolysis process. In other aspects, at least a portion of the heated gas flow can correspond to a gas that is substantially non-reactive under the pyrolysis conditions, such as N₂ or Ar. Optionally, the walls of the reactor can also be heated to supplement the thermal energy of the heated gas flow.

Using a heated gas flow to heat the reactor can also provide an unexpected benefit. By heating the heated gas flow to a temperature above 1000° C. prior to entering the reactor, the gas flow is at a temperature that is above 700° C.-900° C. when the gas flow comes into contact with the catalyst precursors. Because the volume of the catalyst precursors is small relative to the volume of the heated gas flow, the catalyst precursors can be rapidly heated to a temperature of 1000° C. or more. Due to this rapid heating, the catalyst precursors pass through the temperatures of 700° C. to 900° C. on a time scale of milliseconds or less. As a result, deposition of metals from the catalyst precursors on the upstream portions of the walls of the reactor is reduced or minimized, as the catalyst precursors do not spend sufficient time at temperatures between 700° C. to 900° C. to facilitate such deposition. This has the additional benefit of also reducing or minimizing any carbon deposition, since the metal deposits that nucleate the carbon deposition are not present.

With regard to managing removal of heat after performing pyrolysis, so that the pyrolysis product and in-situ catalyst can be reacted to form carbon nanotubes, a heat exchanger can be used to reduce the temperature of the pyrolysis product gas flow. An example of a suitable heat exchanger design is a shell and tube heat exchanger. In this design, a plurality of conduits can pass through the shell of the reactor. This can reduce the temperature within the shell to a desired level for carbon nanotube formation.

With regard to flow management, the injection of the reactant flows into the reactor is performed in a manner so that flow in the initial portion of the reactor is turbulent, with a Reynolds number of 2000 or more, or 5000 or more, or 8000 or more, such as up to 20,000 or possibly still higher. This initial turbulent flow can be converted to a substantially laminar flow (with a Reynolds number of less than 2000) in a later section of the reactor based on the design of the reactor. In the zone where cooling of the flow is desired to allow for formation of carbon nanotubes, the flow can be passed into a shell and tubes heat exchanger section. The “shell” section of the heat exchanger is the portion of the heat exchanger that receives the internal reactor flow. This shell section can be divided into a large plurality of flow channels. Dividing the flow into a plurality of flow channels can provide several advantages. First, the diameter of the individual flow channels can be substantially reduced. Second, the overall cross-sectional area of the reactor available for receiving the flow can be reduced, resulting in a net increase in the flow velocity. The combination of forcing the flow into smaller tubes at a higher velocity can substantially reduce the Reynolds number of the flow, so that what was initially a turbulent flow can be converted into a plurality of laminar flow streams in the flow channels.

It is noted that calculation of a Reynolds number is a well-known procedure based on several pieces of data that are typically readily available. Equation (1) shows the calculation for determining a Reynolds number.

$$Re = \frac{ρ vl}{μ} = \frac{vl}{v} \qquad ( 1 )$$

In Equation (1), ρ is the density of the fluid, v is the velocity of the fluid, l is the characteristic distance (in this case, the diameter of the conduit), μ is the dynamic viscosity of the fluid, and v is the kinematic viscosity of the fluid. As shown in Equation (1), the Reynolds number can be calculated using either a dynamic or a kinematic viscosity, depending on which is more convenient to use.

In various aspects, a Reynolds number can be calculated at a convenient location within the reactor based on the following method. First, mass balance can be used to determine a flow rate within the reactor. The velocity at any given location can then be determined based on the mass flow rate, the pressure within the reactor, and the average diameter of the flow path in the reactor at the location. It is noted that in the latter portion of the reactor, the average diameter of the flow path corresponds to the diameters of the individual tubes in the shell and tube section. The average diameter also corresponds to the characteristic length “l” for Equation 1. For viscosity, the average composition of the gas flow in the reactor can be determined based on input flows. The desired viscosity for the average composition can then be determined based on standard values (and based on the temperature at a given location in the reactor). Based on a Reynolds number calculation at various locations, a mass flow rate into the reactor can be determined that allows the initial stages to have a sufficiently turbulent flow while the later stages can have a sufficiently laminar flow.

In this discussion, a reactor is described that includes a pyrolysis section or zone and a section or zone for carbon nanotube formation. In this discussion, the beginning of the section or zone for carbon nanotube formation is defined as the location where the gas flow in the reactor enters the array of smaller diameter gas flow tubes that are located within the shell and tube heat exchanger portion of the reactor. It is noted that the smaller diameter gas flow tubes are located within the “shell” portion of the heat exchanger. The “tube” portion of the heat exchanger in this design contains a heat transfer fluid, and is not part of the gas flow path for carbon nanotube formation. The end of the pyrolysis zone is defined as either a) the beginning of the section or zone for carbon nanotube formation, or b) if one or more quench streams are introduced into the heated gas flow downstream from exposing the hydrocarbons to a temperature of 1000° C. or more but upstream from the beginning of the section or zone for carbon nanotube formation, then the location of the quench stream corresponds to the end of the pyrolysis zone. If the quench stream is introduced at multiple locations, the farthest upstream location is the end of the pyrolysis zone. It is noted that if a quench stream is present, a quench zone can be present between the end of the pyrolysis zone and the beginning of the carbon nanotube formation zone. The length of such a quench zone can be selected to control the size and/or distribution of the nucleated catalyst particles that facilitate the growth of the carbon nanotubes.

The reaction system for carbon nanotube formation can perform at least three

types of reactions. One reaction is in-situ formation of the catalyst for forming the carbon nanotubes. A second reaction is pyrolysis of thiophene, substituted thiophenes, and/or other hydrocarbons (such as methane) to provide H₂ and carbon for forming the carbon nanotubes. It is noted that thiophene also provides sulfur for in-situ catalyst formation. The third reaction is the formation of the carbon nanotubes on the re-nucleated catalyst particles that were formed in-situ. The various reactions can be managed by controlling the temperature in the various zones of the reactor.

The catalyst for forming the carbon nanotubes can correspond to a floating catalyst—chemical vapor deposition (FC-CVD) type catalyst. Some examples of a suitable FC-CVD catalysts are catalysts that are formed in-situ by decomposition of appropriate precursors. For example, one option for forming an FC-CVD catalyst is to use ferrocene and thiophene precursors. Another option can be to use thiophene (and/or substituted thiophenes) to provide sulfur, and to use carbon nanotubes as the source of the metal for the catalyst. Thiophene at least partially decomposes at roughly 500° C., while ferrocene decomposes at roughly 750° C. Carbon nanotubes decompose at roughly 900° C. Iron sulfide and Fe(CO)₅ are other examples of iron-based precursors that can be used to form an FC-CVD catalyst. More generally, the FC-CVD catalyst can include iron, cobalt, nickel, and/or palladium. General examples of metal precursors can include acetylene precursors, cyclopentadiene precursors, and catalytic metal supported on (optionally recycled) carbon nanotubes. To form the catalyst, the precursors are decomposed and allowed to mix to form the catalyst. The mixing can be performed in any convenient manner. This can include, for example, injecting the precursor flows at an angle relative the direction of flow in the reactor to assist with mixing; inserting internal structures to help create turbulence to facilitate mixing; using various types of nozzles to disperse the precursor flows within the gas flow inside the reactor; and/or any other convenient method. The catalyst is then subsequently cooled to a temperature of roughly 600° C. to 800° C. to allow for carbon nanotube formation. In such a temperature range, the catalyst can serve as a nucleation site for formation of a carbon nanotube. It is noted that the term “catalyst” is used to describe the FC-CVD catalyst because to facilitates the formation of the carbon nanotubes. However, it is understood that at least a portion of the FC-CVD catalyst is consumed during the formation process, as at least part of the iron is incorporated into the nanotube structure during synthesis. In this discussion, the term “catalyst” is defined to include materials that function in the manner of an FC-CVD catalyst.

In order to avoid unwanted side effects, such as deposition of metals and/or coke on the sidewalls of the reactor, the catalyst precursors (such as thiophene and ferrocene) can be injected into the heated gas flow after the gas flow is already at a temperature of 1000° C. or more. This can avoid difficulties of managing decomposition of the catalyst precursor as the catalyst precursor is heated from temperatures of 500° C. or less up to 1000° C. or more. By injecting the precursors into a heated gas flow at a temperature of 1000° C. or more, the amount of time the catalyst precursors are at temperatures between 500° C. and 1000° C. can be reduced or minimized. During injection of the catalyst precursors, the temperature of the heated gas flow can be 1000° C. or more, or 1100° C. or more, or 1200° C. or more, such as up to 1600° C. or possibly still higher.

In still other aspects, when methane or another hydrocarbon stream is used as at least part of the hydrocarbons for forming the carbon nanotubes, substantially all of the methane/other hydrocarbons can be introduced into the reactor downstream from the catalyst formation zone. This can allow the FC-CVD catalyst (or other catalyst) to be present when methane pyrolysis starts to occur, so that substantial pyrolysis in the absence of the catalyst is reduced or minimized. This can increase the likelihood of carbon nanotube formation, as any methane that is pyrolyzed in the absence of the FC-CVD catalyst is more likely to result in coke formation rather than carbon nanotube formation.

### Alternative Thiophene Synthesis and Catalyst Formation—Thiophene Synthesis In-Situ in Reactor for Nanotube Formation

One option for integrating thiophene synthesis and carbon nanotube formation is via having separate reaction vessels for thiophene synthesis and nanotube formation. Another option is to synthesize the thiophene in-situ. In combination with using metal supported on nanotubes as the source of catalyst metal, this can allow for improved heat integration.

The thiophene synthesis conditions described above include a temperature range of roughly 450° C. to 750° C. While this is an effective range for thiophene synthesis, the constraint on the upper end of the temperature range is due in part to considerations related to how to construct a reactor. In particular, limiting the temperature to 750° C. or less can allow thiophene synthesis to be performed using typical types of metals used for reactor construction in a refinery or chemical plant setting. However, thiophene synthesis can still be performed at higher temperatures, such as temperatures between 750° C. to 1200° C., or 900° C. to 1200° C., or 950° C. to 1200° C., or 1000° C. to 1200° C., or 750° C. to 1100° C., or 900° C. to 1100° C.

In some aspects, instead of forming thiophene in a separate vessel and then passing the thiophene-containing reaction products into the vessel(s) for carbon nanotube formation, the thiophene can instead by synthesized in the vessel for carbon nanotube formation. The thiophene synthesis reaction is exothermic. By performing thiophene synthesis in the same reactor vessel as carbon nanotube synthesis, the heat from the thiophene synthesis can be used as a portion of the heat that is needed for the subsequent pyrolysis reaction to form carbon and H₂.

In aspects where thiophene synthesis is performed in the same reactor as carbon nanotube formation, a configuration similar to FIG. 2 can still be used, but the flows passed into the reactor vessel are modified. Thus, this alternative synthesis method with improved heat integration can be illustrated in reference to FIG. 2.

In aspects where thiophene synthesis is performed in the same reactor as carbon nanotube formation, the reactant flow 170 can include the catalytic metal supported on carbon nanotubes as a support, plus at least a portion of the hydrocarbon for pyrolysis. However, thiophene does not need to be included in the reactant flow 170. Instead, the precursors for thiophene formation can be added to reactor 100 at a location (not shown) that is downstream from where reactant flow 170 enters reactor 100 but upstream from pyrolysis zone 110. As explained above, the precursors for thiophene formation can include at least a gas phase sulfur source and C₄₊ alkanes. The catalyst for thiophene synthesis can be located at or near the location where the thiophene precursors are introduced into the reactor 100. The thiophene synthesis reaction can then be performed in the presence of the heated gas stream 175 that is mixed with reactant flow 170.

By performing the thiophene synthesis within the reactor 100, the heat generated during thiophene formation can be at least partially consumed by the surrounding gas phase environment, thus increasing the temperature of the mixture of heated gas flow 175 and reactant flow 170 that is passing through reactor 100. As a result, the heat from thiophene synthesis can be at least partially used to provide heat for the subsequent hydrocarbon pyrolysis in zone 110 of reactor 100. After forming the thiophene, the thiophene (or at least the sulfur from the thiophene) can then combine with the catalytic metal in reactant flow 170 to form the catalyst for carbon nanotube formation.

In some aspects, by integrating thiophene synthesis with carbon nanotube formation, the additional heat generated in-situ in the reactor can reduce the amount of heat the needs to be added to using heater 160 while still maintaining a target temperature for heated gas flow 170. In such aspects, the temperature of heated gas flow 170 after thiophene synthesis but prior to entering pyrolysis zone 110 can be greater than the temperature of heated gas flow 170 prior to entering reactor 110 by 20° C. or more, or 40° C. or more, or 60° C. or more, such as up to 100° C. or possibly still higher. After the synthesis of the thiophene, the reactant flow 170 can be passed into pyrolysis zone 110.

### Carbon Nanotube Formation—Hydrocarbon Pyrolysis and Reactor Heating

Although some pyrolysis of hydrocarbons can occur at temperatures of less than 1000° C., in order to achieve more than 50% conversion (pyrolysis) of methane and/or other hydrocarbons in a reactor, the temperature in the pyrolysis environment can be 1000° C. or more, or 1100° C. or more, or 1200° C. or more, such as up to 1600° C. or possibly still higher. As noted above, this temperature can be achieved within the reactor by using a heated gas flow. Optionally, some supplemental heating of the reactor walls can also be performed. In such optional aspects, the amount of this supplemental heating can be characterized relative to the heat energy content of the heated gas flow. In this discussion, the heat energy content of the heated gas flow is defined as the amount of thermal energy required to heat the gas flow composition from 25° C. to the temperature of the heated gas flow as it enters the reactor. Based on this definition for heat energy content for the heated gas flow, the amount of heat energy added to the reactor per unit time (i.e., a power) can be determined. The average amount of thermal energy per unit time added to the reactor via heating of the sidewalls can correspond to 20% or less of the heat energy content per unit time of the heated gas flow, or 10% or less, or 5% or less, such as down to having substantially no thermal energy added to the reactor through the reactor sidewalls. In aspects where heating of the reactor walls is used, such supplemental heating can further reduce or minimize formation of deposits on the reactor walls.

In some aspects, the heated gas flow for heating the reactor can correspond to a gas flow that is substantially non-reactive relative to the catalyst precursors and the hydrocarbons for pyrolysis. Examples of substantially non-reactive gases can include N₂ and Ar. In other aspects, hydrogen generated by the pyrolysis process (or optionally another source of hydrogen) can be used at least in part as the heated gas flow. In such aspects, the amount of H₂ in the heated gas flow can be 20 vol % or more of the heated gas flow, or 40 vol % or more, or 60 vol % or more, or 80 vol % or more, such as up to having a heated gas flow that is substantially composed of hydrogen (95 vol % or more, such as up to 100 vol %).

Optionally, when an H₂-containing gas is used, the H₂-containing gas can also include CO so that the H₂-containing gas corresponds to a synthesis gas. Synthesis gas can also optionally contain water and/or CO₂. Optionally, CO, CO₂, and/or ethanol can be added to the H₂-containing gas, depending on the type of FC-CVD catalyst that is being formed in-situ.

In some aspects, using an H₂-containing gas for the heated gas flow can provide an additional advantage for further reducing or minimizing carbon deposition within the reactor. Under pyrolysis conditions, both carbon atoms and H₂ are formed. The carbon atoms can have a tendency to deposit on the surfaces of the reactor. However, having an H₂-rich gas phase environment can reduce or minimize the tendency for the carbon atoms to deposit on a surface and/or can facilitate removing carbon atoms that might deposit on a surface. In such an environment, an increased amount of carbon can remain in the gas phase in some form until the gas flow reaches the cooler temperatures in the zone for formation of carbon nanotubes.

One option for heating the gas flow can be to use multiple heating stages. For example, an initial heating stage can correspond to a furnace used for heating reactors, such as the type of furnace used in a steam cracking reaction system. Conventional furnaces can be used to heat a gas flow, such as an H₂-containing gas flow, to a temperature of roughly 1000° C. or possibly higher. Additional heating to further increase the temperature to 1100° C. or more, or 1200° C. or more, can be provided by a variety of methods. One option can be to use electric heating to heat the walls of the conduit containing the gas flow. Although the reactor is of large size, the conduit for heating the gas flow prior to entering the reactor can be sized appropriately to allow for efficient heat transfer. Other options can include induction heating or plasma heating. Because pyrolysis is an endothermic process, the temperature of the gas flow can decrease as the pyrolysis reaction proceeds. Thus, it can be desirable to heat the gas flow to a temperature above 1000° C., so that a sufficient volume within the reactor will be above 1000° C. as the endothermic pyrolysis process cools the flow. Some additional pyrolysis can still occur after the flow cools to below 1000° C., but the reaction rate is slower.

Still another option can be to include electric heating elements within the gas flow. Silicon carbide is an example of a suitable material for forming an electric heating element. Examples of silicon carbide heating elements are sold under the brand name Kanthal® by

Sandvik Materials Technology of Hallstahammar, Sweden. Other examples of materials that can be used to form heating elements can include, but are not limited to, Fc/Cr/Al alloys; molybdenum; tungsten; silicon carbide; and combinations thereof.

After heating the gas flow, the catalyst precursors and the hydrocarbon for pyrolysis (such as a portion of the thiophene synthesis effluent, or methane/natural gas) can be added into the gas flow and/or the reactor. Preferably, the catalyst precursors and hydrocarbons for pyrolysis can be added to the reactor. The volume of the flow for the hydrocarbons for pyrolysis can correspond to 10 vol % or less of the total gas volume that is passed into the reactor, or 5.0 vol % or less, or 3.0 vol % or less, such as down to 1.0 vol %, where the total gas flow includes the heated gas flow, the hydrocarbons for pyrolysis, and the flow for the catalyst precursors. The volume for the flow of the catalyst precursors can correspond to 1.0 vol % or less of the total gas flow volume into the reactor.

The flow of methane, portion of the thiophene synthesis effluent, and/or other hydrocarbons/organic compounds into the reactor can also be partially pre-heated in order to maintain the desired temperature within the reactor after the methane mixes with the heated gas flow. In some aspects, the methane can be pre-heated to a temperature of 200° C. to 500° C., or 200° C. to 400° C. If the catalyst precursors are mixed with the methane/thiophene synthesis effluent prior to entering the reactor, pre-heating the methane (or other hydrocarbon flow) to 500° C. or less will reduce or minimize decomposition of catalyst precursor prior to being mixed with the heated gas flow. Alternatively, if the catalyst precursor is introduced into the heated gas flow separately, the methane/thiophene synthesis effluent can be pre-heated to 200° C. to 800° C., or 200° C. to 600° C., or 400° C. to 800° C.

In some aspects, the methane flow/portion of the thiophene synthesis effluent can be supplemented with a hydrocarbon that forms free radicals under the pyrolysis conditions. By forming free radicals, the temperature needed for methane pyrolysis can be reduced. One option can be to introduce propane and/or butane with the methane feed. Propane and butane are often available as part of a “condensate” stream at natural gas production sites. Another option can be to use a free radical precursor that provides free radicals that have a longer lifetime. Toluene is an example of a hydrocarbon that can provide stabilized free radicals within the pyrolysis environment. When additional hydrocarbons are used to provide free radicals in the pyrolysis environment, the amount of additional hydrocarbons can correspond to 0.1 mol % to 5.0 mol % of the amount of methane introduced into the reactor.

In some aspects, the hydrocarbons for pyrolysis and/or the catalyst precursors can be mixed with the heated gas flow within the reactor. In other aspects, at least one of the hydrocarbons for pyrolysis and the catalyst precursors can be mixed with the heated gas flow prior to entering the reactor. Optionally, a portion of the heated gas flow and/or a portion of the hydrocarbons for pyrolysis can be introduced into the reactor at a downstream location in the reactor relative to the direction of flow. Introducing different portions of the gas flow at different locations within the reactor can assist with managing the reaction profile in the reactor. For example, by adding a portion of the methane at a downstream location in the reactor, the amount of methane available for pyrolysis in the early parts of the reactor can be reduced or minimized, to further reduce the likelihood of early carbon nanotube formation and/or early deposition of carbon on the surfaces of the reactor.

It is noted that the velocity of the gas within the reactor can be relatively high. The velocity within the reactor can determine the residence time of the reactants within the pyrolysis zone. By using a high velocity in combination with a low concentration of hydrocarbons in the total flow (roughly 10 vol % or less) and a temperature greater than 1000° C., a high level of conversion can be achieved while having a low residence time. Having a low residence time in the pyrolysis zone of the reactor can reduce or minimize carbon deposition on surfaces in the reactor prior to the products reaching the zone for carbon nanotube formation. Additionally, because turbulence is desirable in the early portion of the reactor to facilitate formation of the in-situ FC-CVD catalyst, having a relatively high velocity can reduce or minimize the likelihood of any portions of the flow staying in the pyrolysis zone for an extended period of time due to back-mixing. In various aspects, the average residence time for the heated gas flow in the pyrolysis zone can range from 0.05 seconds to 5.0 seconds, or 0.05 seconds to 1.0 seconds, or 0.1 seconds to 5.0 seconds.

### Creating a Cooled, Laminar Flow for Carbon Nanotube Formation

After the pyrolysis zone in the reactor, the gas flow containing the carrier gas (possibly H₂), pyrolysis products (including carbon atoms) and the catalyst for forming the carbon nanotubes can have a Reynolds number of 2000 or more, or 4000 or more, such as up to 20,000 or possibly still higher. This indicates a turbulent flow. The temperature can also still be close to the pyrolysis temperature of 800° C. or more, or 900° C. or more, or 1000° C. or more. In order to form carbon nanotubes in an effective manner, the temperature of the gas flow can be reduced to 750° C. or less, or 700° C. or less, and the Reynolds number of the flow can be reduced to less than 2000, so that the gas flow has laminar flow properties.

One option for cooling the gas flow can be to configure the carbon nanotube zone of the reactor as a shell and tube heat exchanger. In the shell and tube heat exchanger, the gas flow enters the “shell” portion of the heat exchanger. A heat transfer fluid is passed through the tubes to allow for rapid cooling of the gas flow containing the carrier gas, the pyrolysis products, and the catalyst for carbon nanotube formation. This can allow the gas flow to be cooled to a temperature that facilitates carbon nanotube formation, such as a temperature of 600° C. to 800° C. Additionally, within the heat exchanger, a temperature gradient can be present, so that the gas flow continues to cool as the gas travels within the heat exchanger. Due to this variation, the temperature at the beginning of the array of tubes can be between 600° C. to 800° C., while the temperature toward the end of the array of tubes can be lower by 10° C. to 150° C., or 50° C. to 150° C., or 10° C. to 100° C., or 50° C. to 100° C.

In some aspects, further cooling can be performed by adding a quench stream to the gas flow. The quench stream can correspond to H₂, CH₄, or another convenient stream. Preferably the quench stream can include a reduced or minimized amount of H₂O. Addition of a quench stream can assist with cooling the gas flow to a desired temperature for nanotube production.

In aspects where a quench stream is used, at a downstream location, a steam stream can be injected. Adding steam after the temperature of the gas flow is reduced to 800° C. or less, or 750° C. or less, can allow for gasification of amorphous carbon while having only minimal impact on any nanotubes. It is believed that amorphous carbon can be gasified in the presence of steam at temperatures of 700° C. or higher. By contrast, it is believed that temperatures of 900° C. or higher are needed to gasify carbon nanotubes using steam. Addition of steam to gasify amorphous carbon can provide several benefits. First, amorphous carbon that has formed on catalyst particles can be removed, thus providing additional clean nucleation sites for formation of additional carbon nanotubes. Additionally, to the degree that amorphous carbon may have formed as part of a carbon nanotube structure, such amorphous carbon can be removed. This can allow for production of carbon nanotubes with improved morphology.

In addition to cooling the gas flow, the turbulence of the gas flow can also be sufficiently reduced to provide a laminar flow. This can correspond to having a Reynolds number of less than 2000, or 1950 or less, or 1500 or less, or 1000 or less, or 600 or less, such as down to a Reynolds number of 1. The turbulence can be reduced by providing an array of smaller flow tubes within the shell portion of the heat exchanger for receiving the gas flow. Using an array of smaller flow tubes can provide two separate methods for reducing the turbulence in the gas flow. First, passing a gas flow from a larger diameter volume into a smaller diameter volume can reduce the turbulence of the flow. Second, the cross-sectional area for flow of the flow tube array can be smaller than the cross-sectional area of the pyrolysis section of the reactor. This reduction in cross-sectional area means that the velocity of the gas flow will increase, since the net flow rate within the reactor is not changed. By increasing the velocity while decreasing the diameter of the individual conduits that the gas flow is passing through, a substantial decrease in Reynolds number can be achieved.

With regard to tube size, an individual tube in the flow tube array can have a diameter that is smaller than the pyrolysis reactor diameter. A ratio of the average cross-sectional area in the pyrolysis section of the reactor that is available for gas flow versus the average diameter of the individual tubes in the flow tube array can be 10 or more (i.e., 10:1 or more), or 20 or more, or 30 or more, such as up to 100 or possibly still larger. With regard to available cross-sectional area, a ratio of the average cross-sectional area of the pyrolysis section of the reactor available for gas flow versus the average cross-sectional of the flow tube array that is available for gas flow can be 1.1 or more (i.e., 1.1:1 or more), or 1.5 or more, or 2.0 or more, or 3.0 or more, such as up to 10 or possibly still higher. It is noted that the increase in gas velocity will be substantially similar to the ratio of the cross-sectional areas that are available for gas flow. In this discussion, the cross-sectional area available for gas flow at a location refers to the portion of the total cross-sectional area of a conduit or reactor that is open to gas flow and that is in fluid communication with the volume containing the gas flow. Any internal structures within a reactor correspond to cross-sectional area/volume that is not available for gas flow.

It is noted that the total cross-sectional area of the shell and tube heat exchanger portion of the reactor may be greater than the pyrolysis zone of the reactor. However, since the gas flow is being passed into the array of flow tubes within the shell and tube heat exchanger, the cross-sectional area of the shell and tube heat exchanger is not as critical for the overall configuration.

After passing through the flow tube array, the products from the carbon nanotube formation process can be collected. In this final product recovery area, the flow exiting the reactor can be cooled to a temperature of roughly 100° C. or less. Hydrogen formed by the pyrolysis reaction can be withdrawn as a gas phase product, along with any hydrogen that was initially present in the heated gas flow. The carbon nanotubes can be recovered in any convenient manner. For example, the carbon nanotubes can form an aerogel, and a spinning process can be used to draw out a macroscopic scale carbon fibers. As another example, a conveyor belt with a support or collection matrix can be provided in the carbon nanotube formation zone. The nanotubes can deposit on the collection matrix, which is then carried out of the nanotube formation zone by the conveyor belt. The carbon nanotubes can then be recovered from the collection matrix, such as by scraping. A portion of the iron can be incorporated into the carbon nanotubes. Any excess iron can form deposits in the product recovery area.

With regard to yields, 90 vol % or more (or 95 vol % or more, such as up to 100 vol %) of the hydrocarbons introduced into the reactor can be converted into carbon and H₂. For the carbon formed by pyrolysis, 90 mol % or more of the carbon atoms can be passed into the product recovery area. For the iron in the ferrocene catalyst, 50 wt % or more (or 65 wt % or more, or 75 wt % or more, such as up to 100 wt % of the iron can be passed into the product recovery area, either in the form of iron within the carbon nanotubes or a bulk iron-containing phase in the product recovery area. As noted above, the iron and/or other metal(s) incorporated into the nanotubes can subsequently be recovered for use in subsequent synthesis cycles, such as by using an acid treatment to separate the metal(s) from the carbon nanotubes.

### Thiophene Catalyst and Synthesis Method

In various aspects, thiophene synthesis can be performed using a catalyst prepared by impregnating a zeotype support with chromium, calcining the impregnated support to form a catalyst precursor that includes chromium oxide(s), and then sulfiding the catalyst precursor to form a catalyst corresponding to chromium sulfide(s) supported on the zeotype support. In some aspects, additional benefits can be achieved if a zeotype support is a substantially alkali-metal and alkaline earth-metal form zeotype prior to addition of Cr. Such alkali metals and/or alkaline earth metals can be associated with a zeotype framework structure based on the presence of such metals in the synthesis solution for forming the zeotype framework structure. After synthesis, performing ion exchange with an alkali metal is an example of this type of neutralization of acid sites that can provide enhanced catalyst performance. Additionally or alternately, addition of alkali metals to neutralize acidic sites can also be performed during Cr impregnation and/or after Cr impregnation.

Without being bound by any particular theory, it is believed that the improved activity of the thiophene synthesis catalyst is related to the formation of chromium-sulfur compounds and/or complexes within the zeotype framework structure. Having alkali metals and/or alkaline earth metals associated with substantially all of the acidic sites (90% or more) of the zeotype framework structure appears to allow for formation of Cr₂S₃ and/or Cr₃S₄ phases that do not appear to form when chromium is simply deposited on an oxide substrate. The Cr₂S₃ and Cr₃S₄ phase can be observed via XRD. Additionally, after using a catalyst for thiophene synthesis, layered chromium-sulfide phases can be observed via transmission electron microscopy (TEM). These layered phases are believed to correspond to Cr₂S₃. Additionally or alternately, neutralizing the acid sites with alkali metal may provide stabilization for chromium sulfides that have a higher oxidation state for the chromium. Cr₂S₃ and Cr₃S₄ are examples of chromium sulfides with chromium in a higher oxidation state.

In various aspects, the unexpectedly improved activity for synthesis of thiophene (including alkylated thiophenes) and/or reduced coke production during thiophene synthesis can be due in part to having a catalyst where the average stoichiometric ratio of sulfur to chromium in the catalyst is greater than 1.0 to 1. In other words, expressed as a stoichiometric formula, the chromium sulfides in the catalyst can be described as having the formula CrSₓ, where “x” is greater than 1.0. In this definition, the value of “x” is not limited to integers. In this discussion, the average stoichiometry of chromium sulfides on a catalyst sample can be determined by using X-ray diffraction (XRD) on a sulfided catalyst. This can correspond to a catalyst prior to use, or a catalyst after use in thiophene synthesis. Although XRD cannot be used to quantitatively determine the relative amounts of various chromium sulfide phases, it is known that the lowest ratio of sulfur to chromium present in a chromium sulfide is a 1.0 to 1 ratio (CrS). All other phases of chromium sulfides have a ratio of sulfur to chromium greater than 1.0 to 1. Therefore, if any additional phases of chromium sulfide are detected by XRD, such as Cr₂S₃ or Cr₃S₄, the average stoichiometry for the sample will correspond to a sulfur to chromium ratio of greater than 1.0 (i.e., CrSₓ with x greater than 1.0). Thus, even though XRD cannot make quantitative comparisons between phases, XRD can be used to determine whether only CrS is present (x=1.0) or whether chromium sulfide phases other than CrS are present (x>1.0).

In some aspects, it is believed that the presence of alkali metals and/or alkaline earth metals associated with the zeotype framework structure can allow for improved production of thiophene (including alkylated thiophenes) and/or can allow for reductions in coke formation. This is believed to be due to increased formation of CrSₓ phases with a stoichiometric ratio of Cr to S that is greater than 1. Chromium is capable of forming a variety of CrSₓ phases, including (but not limited to) CrS, Cr₂S₃, and Cr₃S₄. In these CrSₓ phases, the oxidation state of the sulfur is generally understood to be −2. Thus, in CrS, the oxidation state of Cr is generally understood to be +2. In Cr₂S₃, the oxidation state of Cr is generally understood to be +3, while in Cr₃S₄, the oxidation state is generally understood to be a mixture of +2 and +3.

Without being bound by any particular theory, it is believed that the combination of having chromium sulfides that includes chromium in an elevated oxidation state; the presence of a zeotype framework structure to provide a “cage-like” environment; and the presence of alkali metals and/or alkaline earth metals associated with the zeotype framework structure, can contribute in a synergistic manner to provide improved activity and/or selectivity for thiophene production in combination with reduced or minimized selectivity for coke production.

With regard to chromium sulfides, it is believed that the presence of chromium in a higher oxidation state can facilitate allowing a chromium sulfide phase to donate a sulfur atom for formation of thiophene and/or an alkylated thiophene in combination with an alkane precursor. It is believed that removing the sulfur from the chromium sulfide results in a change in oxidation state for a Cr atom in a CrSₓ compound. When only CrS is available, removing a sulfur atom requires a Cr atom to undergo a change from a +2 oxidation state to metallic Cr. By contrast, when a phase such as Cr₂S₃ or Cr₃S₄ is available, a sulfur atom can be removed from the chromium sulfide while having only changes in oxidation state for Cr atoms from +3 to +2.

It is further believed that the cage-like structure of the pore network of a zeotype framework may limit the speed of formation of substances with larger numbers of carbon-carbon bonds. By limiting the formation of larger complexes of carbons, this can increase the opportunities for formation of a carbon-sulfur bond as part of a complex containing eight atoms or less, or seven atoms or less, or six atoms or less, or five atoms or less. These small complexes can then have an increased opportunity to form a thiophene ring, as opposed to adding further carbon-carbon bonds and forming coke or a coke precursor.

Additionally or alternately, it is believed that a catalyst including a zeotype support can facilitate formation of layered domains of carbon sulfides. These layered domains can be viewed in a transmission electron microscope image of the sulfided catalyst. It is believed that these layered domains can contribute to the increased activity of chromium sulfides when supported on a zeotype support. Such layered domains are believed to correspond to a Cr₂S₃ phase.

It is still further believed that the presence of the alkali metals and/or alkaline earth metals associated with the zeotype framework structure can assist with formation of thiophene and/or alkylated thiophenes in several ways. First, the presence of the alkali metals and/or alkaline earth metals associated with the zeotype framework structure may allow for formation of sulfide phases corresponding to mixtures of chromium and an alkali metal or alkaline earth metal. These mixed sulfide phases may further facilitate the ability for a sulfide phase to participate in a reaction to form a thiophene or alkylated thiophene. Additionally or alternately, the alkali metals and/or alkaline earth metals can be associated with acid sites in the zeotype framework structure. The presence of such metals can neutralize the acid sites (as opposed to having a hydrogen atom). It is believed that this neutralization of acid sites can reduce or minimize formation of coke during thiophene synthesis.

A wide variety of zeotype frameworks can be used as the support for a thiophene synthesis catalyst. Suitable zeotype frameworks can include “large pore” zeotypes and “medium pore” zeotypes. Large pore zeotypes have a largest pore channel with an average pore diameter of ˜0.65 nm or more, or ˜0.70 nm or more, such as possibly up to ˜1.0 nm. In some aspects, such large pore zeotypes can have a largest pore channel that corresponds to a 12-member ring in the zeotype framework. Medium pore zeotypes can have a largest pore channel with an average pore diameter of less than ˜0.70 nm, such as ˜0.50 nm to ˜0.70 nm. In some aspects, such medium pore zeotypes can have a largest pore channel that corresponds to a 10-member ring in the zeotype framework.

Some examples of large pore molecular zeotype frameworks can include FAU, which includes zeotypes such as USY and faujasite, and MWW, which includes zeotypes such as MCM-22 and MCM-49. Additional large pore zeotypes that can be employed in accordance with the present invention include both natural and synthetic large pore zeotypes. Non-limiting examples of natural large-pore zeotype frameworks include gmelinite, chabazite, dachiardite, clinoptilolite, faujasite, heulandite, analcite, levynite, erionite, sodalite, cancrinite, nepheline, lazurite, scolecite, natrolite, offretite, mesolite, mordenite, brewsterite, and ferrierite. Non-limiting examples of synthetic large pore zeotype frameworks are zeolites X, Y, A, L. ZK-4, ZK-5, B, E, F, H, J, M, Q, T, W, Z, alpha, beta, omega, REY, and USY, as well as MSE framework materials (such as MCM-68). In some aspects, a large pore zeotype support can correspond to a zeolitic support (i.e., only oxides of silicon and aluminum in the zeotype framework structure).

Medium-pore size zeotype materials can include, but are not limited to, crystalline materials having a zeotype framework of MFI, MFS, MEL, MTW, EUO, MTT, HEU, FER, and TON. Non-limiting examples of such medium-pore size zeotypes include ZSM-5, ZSM-12, ZSM-22, ZSM-23, ZSM-34, ZSM-35, ZSM-38, ZSM-48, ZSM-50, silicalite, and silicalite 2. An example of a suitable medium pore zeotype can be ZSM-5, described (for example) in U.S. Pat. Nos. 3,702,886 and 3,770,614. Other suitable zeotypes can include ZSM-11, ZSM-12, ZSM-21, ZSM-38, ZSM-23, and ZSM-35. As mentioned above SAPOs, such as SAPO-11, SAPO-34, SAPO-41, and SAPO-42 can also be used herein. Non-limiting examples of other medium pore zeotype frameworks that can be used herein include chromosilicates; gallium silicates; iron silicates; aluminum phosphates (AlPO), such as AlPO-11; titanium aluminosilicates (TASO), such as TASO-45; boron silicates; titanium aluminophosphates (TAPO), such as TAPO-11, and iron aluminosilicates.

The large-pore size zeotype framework structures and/or medium-pore size zeotype framework structures used herein can include “crystalline admixtures” which are thought to be the result of faults occurring within the crystal or crystalline area during the synthesis of the zeotypes. Examples of crystalline admixtures of ZSM-5 and ZSM-11 can be found in U.S. Pat. No. 4,229,424, incorporated herein by reference. The crystalline admixtures are themselves zeotypes, in contrast to physical admixtures of zeotypes in which distinct crystals of crystallites of different zeotypes are physically present in the same catalyst composite or hydrothermal reaction mixtures.

Optionally, prior to addition of Cr to a zeotype framework structure material, the zeotype framework structure can be combined with a binder. Any convenient weight ratio of zeotype framework structure to binder can be used. The amount of binder in the combined zeotype and binder composition can correspond to 10 wt % to 90 wt % of the composition, based on the weight of zeotype and binder only.

In some aspects, prior to addition of Cr to a zeotype support, the zeotype support can be in a form where the acidic sites in the zeotype framework structure are substantially neutralized. This can be achieved in any convenient manner. In some aspects, the initial synthesis of a zeotype material can allow for formation of a zeotype material with neutralized acid sites. For example, some zeotype synthesis methods use an alkali hydroxide (such as NaOH) and/or an alkaline earth hydroxide (such as CaOH) as part of the synthesis mixture for forming the zeotype. This results in a zeotype where substantially all of the acidic sites (90% or more) in the zeotype framework structure are neturalized with ions of an alkali metal (such as Na or K) and/or an alkaline earth metal (such as Mg or Ca). In other aspects, ion exchange can be performed on a zeotype to exchange acidic sites (typically terminated by hydrogen) with an alkali metal. In yet other aspects, alkali metal ion exchange can be performed during and/or after impregnation of a zeotype support with Cr. While this can be at least partially effective, it is believed that unexpectedly improved activity/selectivity for thiophene production can be achieved when neutralization with an alkali metal/alkaline earth metal is performed prior to impregnation with Cr.

It is believed that still further unexpectedly improved activity/selectivity for thiophene production can be achieved when sufficient alkali metal and/or alkaline earth metal is present in the synthesis solution to form a substantially alkali metal-and alkaline earth-metal form zeotype. This is in contrast to an “H-form” zeotype, where a substantial portion of the acid sites of the zeotype framework structure are terminated by a hydrogen. Such H-form zeotypes can have higher Alpha values based on this increased acidity. Due to the nature of the thiophene synthesis reaction conditions, it is believed that such higher acidity zeotypes contribute to coke formation. This is also in contrast to zeotypes where the counterion for the acid sites is an amine or ammonium style counterion, or some other type of counterion that does not correspond to an alkali metal or an alkaline earth metal.

In this discussion, a “substantially alkali-metal form zeotype” or a “substantially alkali-metal form zeotype framework structure” is defined as a zeotype where a substantial portion of the acid sites in the zeotype framework structure are associated with/exchanged/occupied by an alkali metal ion. In this discussion, a “substantially alkaline earth-metal form zeotype” or a “substantially alkaline earth-metal form zeotype framework structure” is defined as a zeotype where a substantial portion of the acid sites in the zeotype framework structure are associated with/exchanged/occupied by an alkaline earth metal ion. In this discussion, a “substantially alkali-metal and alkaline earth-metal exchanged zeotype” or a “substantially alkali-metal and alkaline earth metal-exchanged zeotype framework structure” is defined as a zeotype where a substantial portion of the acid sites in the zeotype framework structure are associated with/exchanged/occupied by an alkali metal ion and/or an alkaline earth metal ion. It is noted that under these definitions, a “substantially alkali-metal and alkaline earth-metal form zeotype” is broad enough to cover zeotypes that include only alkali metals or only alkaline earth metals.

One option for forming a substantially alkali-metal/alkaline earth-metal form zeotype is based on the initial synthesis of the zeotype. For many zeotypes, the typical synthesis solution for forming the zeotype framework structure includes addition of a base to achieve a desired pH in the synthesis mixture. One option for forming a substantially alkali-metal/alkaline earth-metal form zeotype is to include the alkali metal and/or alkaline earth metal as the counter-ion for at least a portion of the base included in the synthesis mixture. This can correspond to, for example, including sodium hydroxide (alkali metal counter-ion) or calcium hydroxide (alkaline earth metal counter-ion) as the base. In this discussion, if a synthesis mixture includes a hydroxide base (such as sodium hydroxide or calcium hydroxide), and if 50 wt % or more of the hydroxide base corresponds to an alkali metal hydroxide, the zeotype resulting from the synthesis mixture is defined as a substantially alkali-metal form zeotype. In this discussion, if a synthesis mixture includes a hydroxide base, and if 50 wt % or more of the hydroxide base corresponds to an alkaline earth metal hydroxide, the zeotype resulting from the synthesis mixture is defined as a substantially alkaline earth-metal form zeotype. In this discussion, if a synthesis mixture includes a hydroxide base, and if 50 wt % or more of the hydroxide base corresponds to at least one of an alkali metal hydroxide and an alkaline earth metal hydroxide, the zeotype resulting from the synthesis mixture is defined as a substantially alkali-metal and alkaline earth-metal form zeotype. It is noted that a “substantially alkali-metal or alkaline earth-metal form zeotype” can be formed directly from the initial synthesis mixture for forming the zeotype if the synthesis mixture includes a suitable source of alkali metal and/or alkaline earth metal.

Another option for forming a substantially alkali-metal form/alkaline earth-metal form zeotype is to associate alkali metals/alkaline earth metals with the zeotype after synthesis but prior to impregnation/other addition of chromium to the zeotype support. This can be accomplished, for example, by ion exchange, incipient wetness impregnation, and/or any other convenient method for exposing the zeotype to a solution containing alkali metal ions and/or alkaline earth metal ions. For this type of ion exchange, an excess of the alkali metal ions/alkaline earth metal ions should be available. Many options are available for determining whether an excess is present. If the number of acid sites available per gram of zeotype is known, then a stoichiometric calculation can be performed. If the number of acid sites is not known, then one of various types of proxies can be used for providing an excess of alkali metal ions/alkaline earth metal ions. One proxy can be if the zeotype is exposed to a soluble form (such as a water soluble form) of metal salt, where a) 50 mol % or more of the metals in the solution correspond to alkali metals and/or alkaline earth metals, and b) the weight of the alkali metal salt and/or alkaline earth metal salt in the solution is equal to or greater than the weight of the zeotype that is contacted by the solution.

In addition to having a substantially alkali metal-and alkaline earth-metal zeotype, the zeotype support can also be impregnated with Cr. This can be performed in any convenient manner, such as by incipient wetness. For example, a solution of a Cr salt can be formed, such as a solution of chromium (III) nitrate nonahydrate in water. A material containing a zeotype framework structure (such as USY, MCM-49, or ZSM-5) can be exposed to the solution containing the Cr salt. The resulting material can then optionally be dried to remove water while leaving behind the Cr. Examples of drying steps can include exposing the resulting material to a temperature of 80° C. to 200° C. Drying can be performed for a convenient period of time, such as 0.5 hours to 24 hours. Due to the relatively low temperature during a drying procedure, either an inert atmosphere or an oxygen-containing atmosphere (such as air) can be used during the drying procedure.

In various aspects, the amount of Cr supported on a zeotype support can be from 1.0 wt % to 20 wt %, or 1.0 wt % to 12 wt %, or 1.0 wt % to 8.0 wt %, or 3.0 wt % to 20 wt %, or 3.0 wt % to 12 wt %, or 3.0 wt % to 8.0 wt %, or 5.0 wt % to 20 wt %, or 5.0 wt % to 12 wt %, or 5.0 wt % to 8.0 wt %. In aspects where the zeotype support includes both a zeotype framework structure and a binder, the amount of Cr on the zeotype support corresponds to the amount of Cr on the combined weight of zeotype plus binder.

Optionally, an additional ion exchange/incipient wetness procedure using an alkali metal salt and/or an alkaline earth metal salt can be performed after impregnating the zeotype support with the Cr. This optional addition of alkali metal and/or alkaline earth metal after impregnation with Cr can assist with further neutralization of acidic sites after impregnation with Cr.

After impregnating the zeotype support with Cr (and after any other metal impregnation/ion exchange, such as addition of alkali metals and/or alkaline earth metals to neutralize acid sites), the resulting Cr-impregnated zeotype support can be exposed to a calcining step in an oxygen-containing environment in order to form a catalyst precursor that includes chromium oxide. Calcination can be performed at a temperature of 300° C. to 650° C. Air, such as flowing air, is an example of a suitable oxygen-containing atmosphere. Calcination can be performed for a convenient period of time, such as 0.5 hours to 24 hours.

After forming a catalyst precursor, the catalyst precursor can be sulfided to form a thiophene synthesis catalyst. For example, a catalyst precursor can be exposed to a gas-phase sulfiding agent, such as H₂S, at a sulfidation temperature for a period of time. During sulfidation, the H₂S can be mixed with one or more diluent gases, such as N₂, to allow for control over the rate of sulfidation. Sulfidation of the catalyst precursor can be performed at a temperature ranging from 400° C. to 600° C., or 500°° C. to 600° C. The catalyst precursor can be sulfided for a period of time ranging from 1.0 hours to 8.0 hours. Examples of sulfiding agents can include, but are not limited to, H₂S, CS₂, S₂, dimethyl disulfide, and t-butyl polysulfide.

Sulfidation of the catalyst precursor results in formation of a catalyst that includes chromium sulfide(s) supported on the zeotype support. The sulfide(s) on the zeotype support, as detectable by X-Ray Diffraction (XRD), can include but are not limited to Cr₂S₃, CrS, Cr₃S₄, and combinations thereof.

### Alternative Catalysts for Thiophene Synthesis

In addition to chromium sulfide(s) supported on a zeotype support, various other types of catalysts can potentially be used for thiophene formation based on a gas phase reaction of alkanes with a gas-phase sulfur compound.

One example of an alternative catalyst can be formed from a catalyst precursor including Sm₂O₃. The Sm₂O₃ can be supported on a refractory oxide (such as silica or alumina) and/or on a zeotype support. Optionally, an alkali metal can also be impregnated on such a catalyst precursor. The catalyst precursor can be converted to a catalyst by gas phase sulfidation.

Another example of an alternative catalyst corresponds to a catalyst including chromium sulfide and an alkali metal oxide supported on alumina (or another refractory oxide). This is the type of catalyst currently used for thiophene production when using alcohols (instead of alkanes) as the starting reagent.

Still other examples of alternative catalysts can be catalysts that include Ni, Co, Mo, W, V, or a combination thereof, supported on a support. The support can correspond to a refractory oxide and/or a zeotype support. Optionally, an alkali metal can also be impregnated on the catalyst precursor for forming such a catalyst prior to sulfidation.

### Examples—Initial Preparation of Thiophene Synthesis Catalysts

Three groups of potential catalyst precursor for thiophene synthesis catalysts were prepared. A first group of catalyst precursors corresponded to transition metal oxides, optionally in combination with an alkali metal oxide, supported on alumina or silica supports. A second group of catalyst precursors corresponded to chromium or molybdenum oxides, optionally in combination with an alkali metal oxide, supported on a zeotype support. A third group of catalyst precursors corresponded to catalyst precursors based on Sm₂O₃.

After forming the catalyst precursors, the precursors were sulfided in the presence of H₂S at 550° C.

### Examples 1 to 5 Catalyst Precursors with Alumina or Silica Supports

For the first group of catalysts, the general synthesis method was to start with a support corresponding to Versal 300 Alumina. A transition metal reagent was dissolved in water and then impregnated on the alumina. The resulting solid was then dried at 120° C. for 3 to 4 hours and calcined at 550° C. for 6 hours with continuous air flow at a ramp rate of 3° C. per minute with continuous air flow. If an alkali metal oxide was also added, the alkali metal oxide was dissolved in water, impregnated on the support (after impregnation with the transition metal), dried at 120° C. for 4 hours and then calcined at 350° C. at 6 hours under continuous air flow.

The catalyst precursors made according to this method were 20 wt % Cr₂O₃ on alumina (Example 1); 1.5 wt % K₂O/20 wt % Cr₂O₃ on alumina (Example 2); 20 wt % V₂O₅ on alumina (Example 3); 1.5 wt % K₂O/20 wt % V₂O₅ on alumina (Example 4); 20 wt % molybdenum oxide on alumina (Example 5); and CoMo on silica (roughly 20 wt % CoMo, 4:3 molar ratio of Co to Mo). Examples of reagents used for the catalyst synthesis include Versal 300 alumina; chromium (III) nitrate nonahydrate; and ammonium molybdate tetrahydrate.

### Examples 6 to 10—Catalyst Precursors with Zeotype Supports

Example 6:10 wt % Cr₂O₃ on ZSM-5. ZSM-5 was synthesized according to a conventional synthesis method using ammonium hydroxide as the base for adjusting the pH of the synthesis mixture. Chromium (III) nitrate nonahydrate, 16.6 g, was dissolved in 24 ml of deionized water. The solution was impregnated onto 30.6 g of ZSM-5. The resulting solid was dried at 120° C. for 6 hours, and calcined at 550° C. for 6 hours with air flow.

Example 7:5.0 wt % MoO₃ on ZSM-5. Ammonium heptamolybdate tetrahydrate, 1.84 g, was dissolved in 30 ml of deionized water. The solution was impregnated onto 30 g of ZSM-5. The ZSM-5 corresponded to a substantially fully sodium-metal form due to the presence of sodium in the synthesis environment. The resulting solid was dried at 120° C. for 4 hrs and calcined at 550° C. for 6 hrs under continuous air flow.

Example 8:5.0 wt % Cr₂O₃ on ZSM-5. Chromium (III) nitrate nonahydrate, 7.9 g, was dissolved in 30 ml of deionized water. The solution was impregnated onto 30 g of ZSM-5. The ZSM-5 corresponded to a substantially sodium-metal form due to the presence of sodium in the initial ZSM-5 synthesis environment. The resulting solid was dried at 120° C. for 4 hrs and calcined at 550° C. for 6 hrs under continuous air flow.

Example 9:5.0 wt % Cr₂O₃ on USY. 30 g of USY was impregnated with 7.9 g of chromium (III) nitrate nonahydrate dissolved in 30 cc of deionized water. The USY was a low acidity version that was substantially sodium-metal form due to the presence of sodium in the initial USY synthesis environment. The resulting solid was dried at 120° C. for 4 hrs. Potassium nitrate, 1.3 g, was dissolved in 30 cc of deionized water and impregnated onto the dried sample. It was dried at 120° C. for 6 hrs and calcined at 550° C. for 6 hrs under continuous air flow.

Example 10:5.0 wt % Cr₂O₃ on MCM-49. MCM-49, 30 g, was impregnated with 7.9 g of chromium (III) nitrate nonahydrate dissolved in 30 cc deionized water. Due to the nature of the MCM-49 synthesis, the MCM-49 was partially hydrogen-terminated prior to the chromium oxide impregnation, as an alkali metal or alkaline earth metal was not included in the synthesis mixture. The resulting solid was dried at 120° C. for 4 hrs and calcined at 550° C. for 6 hrs under continuous air flow. After the chromium oxide impregnation, the resulting solid was further impregnated with 1.3 g of KNO₃ dissolved in 30 cc of deionized water. Same drying and calcination procedure was repeated.

### Testing Apparatus

The catalysts were loaded into a quartz reactor as a bed and sulfided as described above to form sulfided catalyst. After sulfidation, the resulting catalyst was exposed to a gas flow containing 5.0% N₂, 14.0% C₄H₁₀, 14.0% S₂, and 66.5% H₂S. The S₂ was added to the feed by using the H₂S as a sweep gas over liquid S₂ at a temperature of 150° C. The H₂S and S₂ were then combined with the remaining portions of the feed and the feed was heated to 350° C. prior to exposure to the catalyst. The quartz reactor was maintained at 550° C. during exposure to the feed. The feed was exposed to the catalyst at roughly atmospheric pressure (roughly 100 kPa-a). The reaction system did not include recycle, so the results generated correspond to “single pass” reactivity.

Table 1 shows results from exposing the feed to the various catalysts corresponding to Examples 1 to 5. In Table 1, “% conversion” is the amount of conversion of the n-butane in the feed; “% thiophene selectivity” is the weight percent of the conversion product that corresponds to thiophene; “% thiophene yield” corresponds to the weight percent of thiophene relative to the weight of the feed; “% coke yield” is the weight percent of the conversion product that corresponds to coke. It is noted that in Tables 1, 2, and 3, to the degree that the thiophene yield plus coke yield corresponds to less than 100%, the balance of the yield corresponds to either light ends (C₃₋) or a liquid (optionally sulfided) product. Other than coke formation on the catalyst, a tar-like or solid product was not observed after testing of any of the examples.

TABLE 1
Thiophene Synthesis for Examples 1 to 5

| | % con- | % thiophene | % thiophene | % coke |
|---|---|---|---|---|
| | version | selectivity | yield | yield |
| Example 1: 20% Cr₂O₃ | 66.0 | 30.4 | 20.1 | 45.2 |
| on Al₂O₃ | | | | |
| Example 2: 1.5% K₂O/ | 41.7 | 49.8 | 20.8 | 19.7 |
| 20% Cr₂O₃ on Al₂O₃ | | | | |
| Example 3: 20% V₂O₅ | 60.5 | 16.8 | 10.2 | 73.2 |
| on Al₂O₃ | | | | |
| Example 4: 1.5% K₂O/ | 48.5 | 32.8 | 15.9 | 53.6 |
| 20% V₂O₅ on Al₂O₃ | | | | |
| Example 5: 1.5% K₂O/ | 35.0 | 6.5 | 2.3 | 64.1 |
| 20% MoO₃ on Al₂O₃ | | | | |

As shown in Table 1, Example 2 provided the best overall combination of thiophene selectivity, thiophene yield, and coke yield. It is noted that the conversion for Example 2 is lower than the conversion for Example 1. However, even if recycle was used, the coke yield for the catalyst in Example 2 would be substantially lower than any of the other catalysts. The addition of the alkali metal in Examples 4 and 5 also appeared to mitigate coke formation, but from a higher baseline level.

Table 2 shows results from testing of Examples 6-10.

TABLE 2
Thiophene Synthesis for Examples 6 to 10

| | % con- | % thiophene | % thiophene | % coke |
|---|---|---|---|---|
| | version | selectivity | yield | yield |
| Example 6: 10% Cr₂O₃ | 69.5 | 10.9 | 7.6 | 57.0 |
| on ZSM-5 | | | | |
| Example 7: 5.0% MoO₃ | 36.1 | 35.0 | 12.6 | 43.2 |
| on Na-form ZSM-5 | | | | |
| Example 8: 5.0% Cr₂O₃ | 80.0 | 55.6 | 44.5 | 25.2 |
| on Na-form ZSM-5 | | | | |
| Example 9: 1.5% K₂O/ | 52.0 | 59.9 | 31.2 | 10 |
| 5.0% Cr₂O₃ on Na-form | | | | |
| USY | | | | |
| Example 10: 1.5% K₂O/ | 31.5 | 53.6 | 16.9 | 8.7 |
| 5.0% Cr₂O₃ on partially | | | | |
| H-form MCM-49 | | | | |

Table 2 illustrates the unexpected nature of the benefits of using chromium sulfides supported on a substantially alkali metal-form (and/or substantially alkaline earth-metal form) zeotype support. As shown in Table 2, using a zeotype support without having alkali metals and/or alkaline earth metals for acid neutralization (Example 6) resulted in low thiophene production combined with high coke selectivity. In Example 7, the same type of zeotype support used in Example 8 was used to support a molybdenum catalyst. This also resulted in substantial coke formation and low thiophene yield. However, by using a substantially alkali-metal form zeotype support in combination with chromium as a catalytic metal (Examples 8 and 9), it was unexpectedly found that high butane conversions were achieved in combination with high thiophene selectivity and low coke yield. It is noted that treatment with alkali metal after impregnation with chromium (Example 10) provided unexpectedly low coke selectivity, but at lower alkane conversion. Thus, it appears that achieving a substantially alkali-metal and/or alkaline earth-metal form for the zeotype support prior to chromium impregnation provided the additional advantage of combining high alkane conversion with low coke yield.

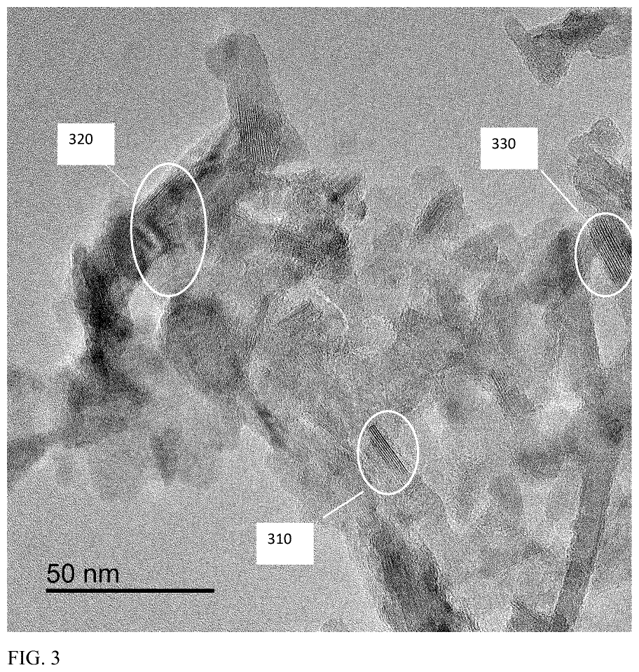

Based on the favorable results for Examples 8-9, the catalyst from Example 9 was analyzed further using transmission electron microscopy (TEM). FIG. 3 shows a TEM micrograph of the sulfided catalyst. As shown in FIG. 3, regions 310, 320, and 330 correspond to examples of regions that show a layered structure that is separate from the crystal structure of the USY support. It is believed that the layered structures (such as the structures in regions 310, 320, and 330) are indicators of a layered chromium sulfide phase that can unexpectedly facilitate improved thiophene synthesis results. This phase can be formed when a zeotype support that is substantially in alkali-metal and/or alkaline earth-metal form is used as a support for a chromium sulfide catalyst.

### Example 11—Characterization of Liquid Product

As noted above a liquid product including at least hydrocarbons and sulfided hydrocarbons was formed under the synthesis conditions. The liquid product generated from the testing of the catalyst in Example 8 was further characterized using gas chromatography-mass spectrometry (GC-MS) to identify compounds within the liquid product.

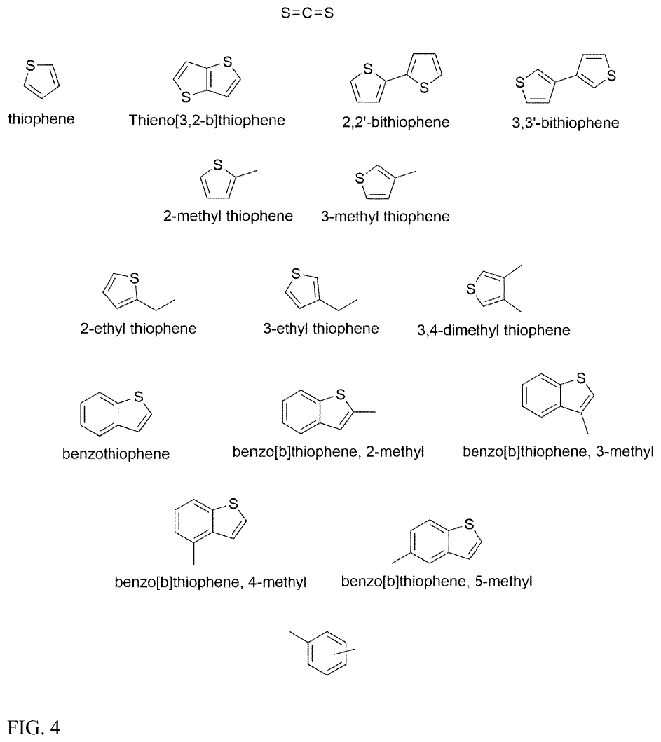

FIG. 4 shows examples of compounds that were detected by GC-MS in the liquid product. It is noted that some still larger compounds may have been formed, but the compounds detected were limited based on the compounds that could be readily volatilized in the gas chromatography apparatus. As shown in FIG. 4, a variety of 1-ring and 2-ring sulfur-containing compounds were formed, including thiophene, various alkylated thiophenes, benzothiophene, various alkylated benzothiophenes, bithiophenes, and bienothiophene (two fused thiophene rings). Additionally, as indicated by the bottom chemical structure in FIG. 4, a variety of alkylated benzenes (as well as unsubtituted benzene) were also detected.

### Additional Embodiments

Embodiment 1. A method of making carbon nanotubes, comprising: exposing a first feedstock comprising one or more C₄ to C₁₆ alkanes and a second feedstock comprising a gas phase sulfur source to a synthesis catalyst under thiophene synthesis conditions, to form a synthesis effluent comprising thiophenes, alkylated thiophenes, or a combination thereof; heating a gas flow to a temperature of 1000° C. or more to form a heated gas flow; passing the heated gas flow into a reactor comprising a pyrolysis zone, the pyrolysis zone comprising an average cross-sectional area that is available for gas flow; mixing i) a catalytic metal precursor comprising a catalytic metal and ii) at least a portion of the synthesis effluent with the heated gas flow to form a heated gas flow mixture, the heated gas flow mixture comprising 10 vol % or less of hydrocarbons, thiophenes, and alkylated thiophenes; maintaining the heated gas flow mixture in the pyrolysis zone at a temperature of 1000° C. or more for a pyrolysis residence time to form an intermediate product flow comprising H₂, carbon, and catalyst comprising the catalytic metal; cooling the intermediate product flow to a temperature of 800° C. or less; and passing the intermediate product flow into an array of gas flow tubes within the reactor to form a carbon nanotube product flow, wherein a ratio of an average cross-sectional area of the pyrolysis zone that is available for gas flow to an average cross-sectional area of the array of gas flow tubes is 1.1 or more, or wherein a ratio of an average cross-sectional of the pyrolysis zone that is available for gas flow to an average cross-sectional area of a tube in the array of gas flow tubes is 10 or more, or a combination thereof.

### Embodiment 2. The method of Embodiment 1, wherein the catalytic metal comprises Fe, Co, Ni, Pd or a combination thereof.

Embodiment 3. The method of any of the above embodiments, wherein the catalytic metal precursor comprises catalytic metal recovered from carbon nanotubes, the catalytic metal optionally being recovered from at least a portion of the carbon nanotube product flow.

Embodiment 4. The method of Embodiment 3, wherein the catalytic metal precursor comprises a catalytic metal precursor formed from catalytic metal recovered from at least a portion of the carbon nanotube product flow and a recycle portion of the carbon nanotube product flow.

Embodiment 5. The method of any of the above embodiments, wherein the synthesis effluent is mixed with the heated gas flow by exposing the first feedstock and second feedstock to the synthesis catalyst in the presence of the heated gas flow, the thiophene synthesis conditions comprising a temperature of 900° C. or higher; or wherein the thiophene synthesis conditions comprise a temperature of 450° C. to 750° C.

Embodiment 6. The method of any of the above embodiments, i) wherein the heated gas flow comprises 80 vol % or more of H₂; ii) wherein the heated gas flow further comprises CO, CO₂, ethanol, or a combination thereof; iii) wherein the intermediate product flow further comprises CO, CO₂, ethanol, or a combination thereof; or iv) a combination of two or more if i), ii), and iii).

Embodiment 7. The method of any of the above embodiments, wherein at least a portion of the synthesis effluent is mixed with the heated gas flow after entering the reactor, or wherein substantially all of the synthesis effluent is mixed with the heated gas flow after entering the reactor.

Embodiment 8. The method of any of the above embodiments, wherein cooling the product flow to a temperature of 800° C. or less comprises passing the product flow into a shell and tube heat exchanger, the array of tubes being located within the shell and tube heat exchanger.

Embodiment 9. The method of any of the above embodiments, wherein the shell and tube heat exchanger further comprises heat exchanger tubes, and wherein at least a portion of the gas flow comprises a heat transfer fluid that is passed through the heat exchanger tubes.

Embodiment 10. The method of any of the above embodiments, wherein the one or more C₄ to C₁₆ alkanes comprise n-butane.

Embodiment 11. The method of any of the above embodiments, wherein the first feedstock further comprises one or more C₄ to C₁₀ alkenes, wherein the synthesis effluent further comprises C₄₊ alkanes, and wherein the first feedstock comprises a recycle portion of the C₄₊ alkanes.

Embodiment 12. The method of any of the above embodiments, wherein the synthesis catalyst comprises a support comprising a) a substantially alkali-metal form zeotype framework structure, b) a substantially alkaline earth-metal form zeotype framework structure, or c) a substantially alkali-metal and alkaline earth-metal form zeotype framework structure, the zeotype framework structure having a 10-member ring pore channel or a 12-member ring pore channel as the largest pore channel; and 1.0 wt % to 10 wt % of chromium sulfide relative to a weight of the sulfided catalyst, the chromium sulfide having an average stoichiometry of CrSₓ, where x is greater than 1.0.

Embodiment 13. The method of Embodiment 12, wherein the zeotype framework structure is synthesized in a) substantially alkali-metal form, b) substantially alkaline earth- metal form, or c) substantially alkali-metal and alkaline earth-metal form.

Embodiment 14. The method of Embodiment 12 or 13, wherein the zeotype framework structure is in a) substantially alkali-metal form, b) substantially alkaline earth- metal form, or c) substantially alkali-metal and alkaline earth-metal form prior to adding chromium to the support.

Embodiment 15. The method of any of Embodiments 12 to 14, a) wherein the zeotype framework structure comprises a zeotype framework of FAU, MFI, MWW, or a combination thereof; b) wherein the support comprises a substantially alkali-metal form zeotype framework structure, the alkali metal comprising sodium, potassium, or a combination thereof; c) wherein the support comprises a substantially alkaline earth-metal form zeotype framework structure, the alkaline earth metal comprising magnesium, calcium, or a combination thereof; or d) a combination of two or more of a), b) and c).

Additional Embodiment A. The method of any of Embodiments 1 to 2 or 5 to 15, wherein the catalytic metal precursor comprises ferrocene.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A method of making carbon nanotubes, comprising:
exposing a first feedstock comprising one or more C₄ to C₁₆ alkanes and a second feedstock comprising a gas phase sulfur source to a synthesis catalyst under thiophene synthesis conditions, to form a synthesis effluent comprising thiophenes, alkylated thiophenes, or a combination thereof;
heating a gas flow to a temperature of 1000° C. or more to form a heated gas flow;
passing the heated gas flow into a reactor comprising a pyrolysis zone, the pyrolysis zone comprising an average cross-sectional area that is available for gas flow;
mixing i) a catalytic metal precursor comprising a catalytic metal and ii) at least a portion of the synthesis effluent with the heated gas flow to form a heated gas flow mixture, the heated gas flow mixture comprising 10 vol % or less of hydrocarbons, thiophenes, and alkylated thiophenes;
maintaining the heated gas flow mixture in the pyrolysis zone at a temperature of 1000° C. or more for a pyrolysis residence time to form an intermediate product flow comprising H₂, carbon, and catalyst comprising the catalytic metal;
cooling the intermediate product flow to a temperature of 800° C. or less; and
passing the intermediate product flow into an array of gas flow tubes within the reactor to form a carbon nanotube product flow,
wherein a ratio of an average cross-sectional area of the pyrolysis zone that is available for gas flow to an average cross-sectional area of the array of gas flow tubes is 1.1 or more, or wherein a ratio of an average cross-sectional of the pyrolysis zone that is available for gas flow to an average cross-sectional area of a tube in the array of gas flow tubes is 10 or more, or a combination thereof.

2. The method of claim 1, wherein the catalytic metal comprises Fe, Co, Ni, or a combination thereof.

3. The method of claim 1, wherein the catalytic metal precursor comprises catalytic metal recovered from carbon nanotubes.

4. The method of claim 3, wherein the catalytic metal recovered from carbon nanotubes comprises catalytic metal recovered from at least a portion of the carbon nanotube product flow.

5. The method of claim 3, wherein the catalytic metal precursor comprises a catalytic metal precursor formed from catalytic metal recovered from at least a portion of the carbon nanotube product flow and a recycle portion of the carbon nanotube product flow.

6. The method of claim 1, wherein the catalytic metal precursor comprises ferrocene.

7. The method of claim 1, wherein the synthesis effluent is mixed with the heated gas flow by exposing the first feedstock and second feedstock to the synthesis catalyst in the presence of the heated gas flow, the thiophene synthesis conditions comprising a temperature of 900° C. or higher.

8. The method of claim 1, wherein the thiophene synthesis conditions comprise a temperature of 450° C. to 750° C.

9. The method of claim 1, i) wherein the heated gas flow comprises 80 vol % or more of H₂; ii) wherein the heated gas flow further comprises CO, CO₂, ethanol, or a combination thereof; iii) wherein the intermediate product flow further comprises CO, CO₂, ethanol, or a combination thereof; or iv) a combination of two or more if i), ii), and iii).

10. The method of claim 1, wherein at least a portion of the synthesis effluent is mixed with the heated gas flow after entering the reactor, or wherein substantially all of the synthesis effluent is mixed with the heated gas flow after entering the reactor.

11. The method of claim 1, wherein cooling the product flow to a temperature of 800° C. or less comprises passing the product flow into a shell and tube heat exchanger, the array of tubes being located within the shell and tube heat exchanger.

12. The method of claim 1, wherein the shell and tube heat exchanger further comprises heat exchanger tubes, and wherein at least a portion of the gas flow comprises a heat transfer fluid that is passed through the heat exchanger tubes.

13. The method of claim 1, wherein the one or more C₄ to C₁₆ alkanes comprise n-butane.

14. The method of claim 1, wherein the first feedstock further comprises one or more C₄ to C₁₀ alkenes.

15. The method of claim 14, wherein the synthesis effluent further comprises C₄₊ alkanes, and wherein the first feedstock comprises a recycle portion of the C₄₊ alkanes.

16. The method of claim 1, wherein the synthesis catalyst comprises
a support comprising a) a substantially alkali-metal form zeotype framework structure, b) a substantially alkaline earth-metal form zeotype framework structure, or c) a substantially alkali-metal and alkaline earth-metal form zeotype framework structure, the zeotype framework structure having a 10-member ring pore channel or a 12-member ring pore channel as the largest pore channel; and
1.0 wt % to 10 wt % of chromium sulfide relative to a weight of the sulfided catalyst, the chromium sulfide having an average stoichiometry of CrSₓ, where x is greater than 1.0.

17. The method of claim 16, wherein the zeotype framework structure is synthesized in a) substantially alkali-metal form, b) substantially alkaline earth-metal form, or c) substantially alkali-metal and alkaline earth-metal form.

18. The method of claim 11, wherein the zeotype framework structure is in a) substantially alkali-metal form, b) substantially alkaline earth-metal form, or c) substantially alkali-metal and alkaline earth-metal form prior to adding chromium to the support.

19. The method of claim 11, wherein the zeotype framework structure comprises a zeotype framework of FAU, MFI, MWW, or a combination thereof.

20. The method of claim 11, wherein the support comprises a substantially alkali-metal form zeotype framework structure, the alkali metal comprising sodium, potassium, or a combination thereof; or wherein the support comprises a substantially alkaline earth-metal form zeotype framework structure, the alkaline earth metal comprising magnesium, calcium, or a combination thereof.
